(19) United States
(12) Patent Application Publication
(10) Pub. No.: US 2024/0412726 A1
(43) Pub. Date: Dec. 12, 2024

(54) METHOD AND SYSTEM FOR NATURAL LANGUAGE TO POSE RETRIEVAL AND NATURAL LANGUAGE CONDITIONED POSE GENERATION

(71) Applicants: Naver Corporation, Seongnam-si (KR); Naver Labs Corporation, Seongnam-si (KR)

(72) Inventors: Ginger Delmas, Meylan (FR); Philippe Weinzaepfel, Montbonnot-Saint-Martin (FR); Francesc Moreno-noguer, Meylan (FR); Gregory Rogez, Meylan (FR)

(73) Assignees: Naver Corporation, Seongnam-si (KR); Naver Labs Corporation, Seongnam-si (KR)

(21) Appl. No.: 18/534,596

(22) Filed: Dec. 9, 2023

Related U.S. Application Data
(63) Continuation-in-part of application No. 18/376,030, filed on Oct. 3, 2023.
(60) Provisional application No. 63/471,539, filed on Jun. 7, 2023.
(60) Provisional application No. 63/537,973, filed on Sep. 12, 2023.

(51) Int. Cl. G10L 15/197; G10L 15/06; G10L 15/22

(52) U.S. Cl. CPC G10L 15/197; G10L 15/063; G10L 15/22

(57) ABSTRACT

A method and system for text-based pose editing to generate a new pose from an initial pose and user-generated text includes an user input device for inputting the initial pose and the user-generated text; a variational auto-encoder configured to receive the initial pose; a text conditioning pipeline configured to receive the user-generated text; a fusing module configured to produce parameters for a prior Gaussian distribution Nₚ; a pose decoder configured to sample the Gaussian distribution Nₚ and generate, therefrom, the new pose; and an output device to communicate the generated new pose to a user. The variational auto-encoder and the text conditioning pipeline are trained using a PoseFix dataset, wherein the PoseFix dataset includes triplets having a source pose, a target pose, and text modifier.

### PRIORITY INFORMATION

The present application is a continuation-in-part of U.S. patent application Ser. No. 18/376,030, filed on Oct. 3, 2023; said U.S. patent application Ser. No. 18/376,030, filed on Oct. 3, 2023, claims priority, under 35 USC § 119 (e), from U.S. Provisional Patent Application, Ser. No. 63/471,539, filed on Jun. 7, 2023.

The present application claims priority, under 35 USC § 120, from U.S. patent application Ser. No. 18/376,030, filed on Oct. 3, 2023.

The present application claims priority, under 35 USC § 119 (e), from U.S. Provisional Patent Application, Ser. No. 63/537,973, filed on Sep. 12, 2023.

The present application claims priority, under 35 USC § 119 (e), from U.S. Provisional Patent Application Ser. No. 63/471,539, filed on Jun. 7, 2023.

The entire content of U.S. patent application Ser. No. 18/376,030, filed on Oct. 3, 2023, is hereby incorporated by reference. The entire content of U.S. Provisional Patent Application, Ser. No. 63/471,539, filed on Jun. 7, 2023, is hereby incorporated by reference. The entire content of U.S. Provisional Patent Application, Ser. No. 63/471,539, filed on Jun. 7, 2023, is hereby incorporated by reference.

### BACKGROUND

Natural language is leveraged in many tasks of computer vision such as image captioning, cross-modal retrieval, or visual question answering, to provide fine-grained semantic information. While human pose, or other classes of poses, is key to human understanding, conventional three-dimensional (3D) human pose datasets lack detailed language descriptions.

For example, if a text describes a downward dog yoga pose, a reader is able to picture such a pose from this natural language description. However, as noted above, conventional three-dimensional (3D) human pose datasets lack detailed language descriptions to enable the input of this text and retrieve a pose corresponding to the pose pictured by the reader.

While the problem of combining language and images or videos has attracted significant attention, in particular with the impressive results obtained by the recent multimodal neural networks CLIP and DALL-E, the problem of linking text and 3D geometry is largely unexplored.

There have been a few recent attempts at mapping text to rigid 3D shapes, and at using natural language for 3D object localization or 3D object differentiation. More recently, AlFit has been introduced, which is an approach to automatically generate human-interpretable feedback on the difference between a reference and a target motion.

There have also been a number of attempts to model humans using various forms of text. Attributes have been used for instance to model body shape and face images. Others leverage textual descriptions to generate motion, but without fine-grained control of the body limbs.

For example, a conventional process exploits the relation between two joints along the depth dimension.

Another conventional process describes human 3D poses through a series of posebits, which are binary indicators for different types of questions such as ‘Is the right hand above the hips?’ However, these types of Boolean assertions have limited expressivity and remain far from the natural language descriptions a human would use.

Being able to automatically map natural language descriptions and accurate 3D human poses would open the door to a number of applications: for helping image annotation when the deployment of Motion Capture (MoCap) systems is not practical; for performing semantic searches in large-scale datasets, which are currently only based on high-level metadata such as the action being performed for complex pose or motion data generation in digital animation; or for teaching basic posture skills to visually impaired individuals.

Therefore, it is desirable to provide a method or system that appropriately links text and 3D geometry of a human pose.

It is further desirable to provide a method or system that appropriately annotates images of 3D human poses.

It is also desirable to provide a method or system that performs semantic searches for 3D human poses.

Additionally, it is desirable to provide a method or system that uses natural language for 3D human pose retrieval.

Furthermore, it is desirable to provide a method or system that uses natural language to generate 3D human poses.

### BRIEF DESCRIPTION OF THE DRAWINGS

The drawings are only for purposes of illustrating various embodiments and are not to be construed as limiting, wherein:

FIG. 1 illustrates some examples of pose descriptions from PoseScript;

FIG. 2 is an overview of a captioning pipeline;

FIG. 3 illustrates an overview of a training scheme of a retrieval model;

FIG. 4 illustrates a table showing text-to-pose and pose-to-text retrieval results;

FIG. 5 illustrates an overview of a text-conditioned generative model;

FIG. 6 illustrates an example of text-to-pose retrieval;

FIG. 7 is an example of text-conditioned pose generation;

FIG. 8 is a table showing evaluation of the text-conditioned generative model;

FIG. 9 is a table showing a list of elementary posecodes;

FIG. 10 is a table showing conditions for posecode categorizations;

FIG. 11 is a graphical representation of categorizations of angle posecodes;

FIGS. 12 through 14 are graphical representations of categorizations of distance posecodes;

FIG. 15 is a graphical representation of categorizations of relative position posecodes along the y-axis;

FIG. 16 is a graphical representation of categorizations of relative position posecodes along the x-axis;

FIGS. 17 and 18 are graphical representations of categorizations of relative position posecodes along the y-axis;

FIGS. 19 and 20 are graphical representations of categorizations of relative position posecodes along the z-axis;

FIGS. 21 and 22 are graphical representations of categorizations of pitch & roll posecodes;

FIG. 23 is a graphical representation of categorizations of ground contact posecodes;

FIG. 24 illustrates histograms showing a number of posecodes used per caption;

FIG. 25 illustrates histograms showing a number of words per automatic caption;

FIG. 26 is a table showing a list of super posecodes;

FIG. 27 is a table showing a summary of automatic caption versions;

FIG. 28 is a table showing text-to-pose and pose-to-text retrieval results;

FIG. 29 illustrates an example of architecture in which the disclosed methods may be performed;

FIGS. 30-35 show examples of Pose pairs and their annotated modifiers in PoseFix;

FIG. 36 is a block diagram showing a text-based pose editing baseline;

FIGS. 37-40 show examples of qualitative results on the text-based pose editing tasks;

FIG. 41 is a block diagram showing a baseline for correctional text generation;

FIG. 42-46 show examples of qualitative results of correctional feedback generation;

FIG. 47 is a table showing semantic analysis;

FIG. 48 is a table showing number of pairs per split;

FIG. 49 is a table showing number of poses per split;

FIG. 50 is a table showing ablations on text-based pose editing architectures;

FIG. 51 is a table showing ablations on training and augmentation data for the task of text-based pose editing;

FIG. 52 is a table showing pose editing results;

FIG. 53 is a table showing results for text generation with various pose injection;

FIG. 54 is a table showing results for correctional text generation with various data augmentations; and

FIG. 55 illustrates a system for providing feedback to a user trying to achieve a desired pose.

### DETAILED DESCRIPTION

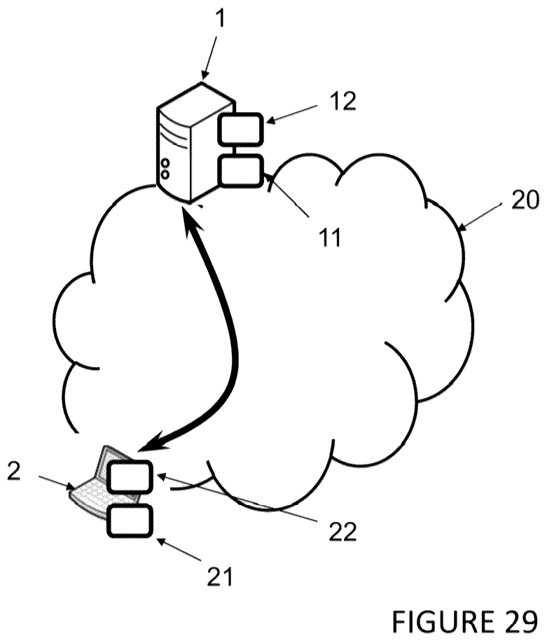

The described methods are implemented within an architecture such as illustrated in FIG. 29, by means of a server 1 and/or a client 2. Each of these devices 1, 2 are typically connected thanks to an extended network 20 such as the Internet for data exchange. Each one comprises data processors 11, 21, and optionally memory 12, 22 such as a hard disk.

In the various embodiments described below, a PoseScript dataset is used, which pairs (maps) a few thousands 3D human poses from AMASS with arbitrarily complex structural descriptions, in natural language, of the body parts and their spatial relationships.

To increase the size of this dataset to a scale compatible with typical data hungry methods, an elaborate captioning process has been used that generates automatic synthetic descriptions in natural language from given 3D keypoints. This process extracts low-level pose information—the posecodes—using a set of simple but generic rules on the 3D keypoints.

The posecodes are then combined into higher level textual descriptions using syntactic rules. Automatic annotations substantially increase the amount of available data and make it possible to effectively pretrain deep models for finetuning on human captions.

As will be discussed in more detail below, the PoseScript dataset can be used in retrieval of relevant poses from large-scale datasets or synthetic pose generation, both based on a textual pose description.

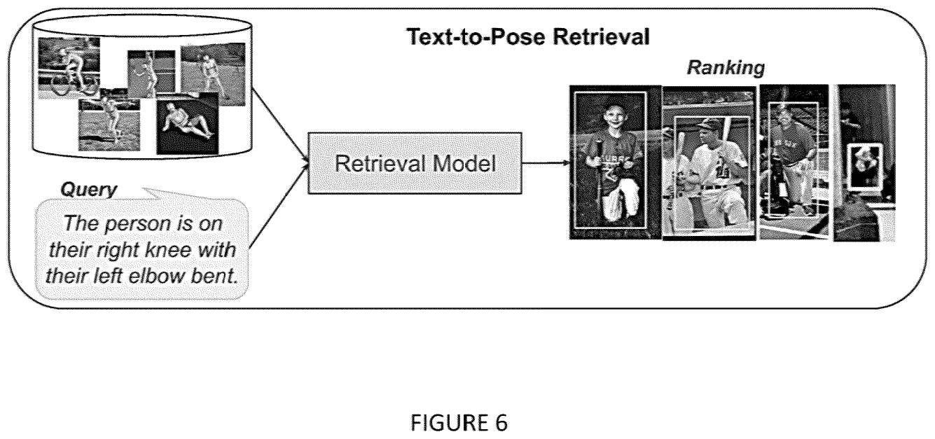

For example, as illustrated in FIG. 6, the PoseScript dataset can be used with text-to-pose retrieval where the goal is to retrieve poses in a large-scale database given a text query.

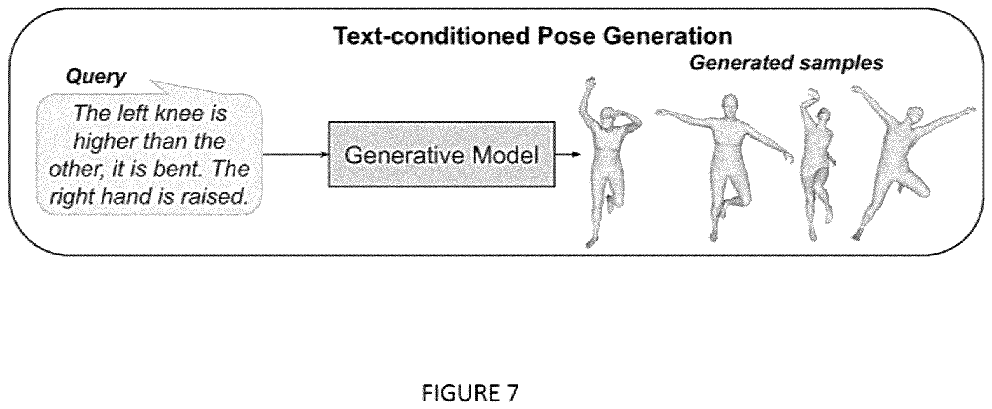

The PoseScript dataset can be used, as illustrated in FIG. 7, text-conditioned pose generation for complex pose or motion data generation in digital animation or teaching basic posture skills to visually impaired individuals.

As will be discussed in more detail below, the method and system maps 3D human poses with arbitrarily complex structural descriptions, in natural language, of the body parts and their spatial relationships using the PoseScript dataset, which is built using an automatic captioning pipeline for human-centric poses that makes it possible to annotate thousands of human poses in a few minutes. In other embodiments, the PoseScript dataset may be built using an automatic captioning pipeline for other class-centric poses that correspond to other classes of animals with expressive poses (e.g., dogs, cats, etc.) or classes of robotic machines with expressive poses (e.g., humanoid robots, robot quadrupeds, etc.).

The automatic captioning pipeline is built on (a) low-level information obtained via an extension of posebits to finer-grained categorical relations of the different body parts (e.g. ‘the knees are slightly/relatively/completely bent’), units that are referred to as posecodes, and on (b) higher-level concepts that come either from the action labels annotated by the BABEL dataset, or combinations of posecodes. Rules are defined to select and aggregate posecodes using linguistic aggregation rules, and convert them into sentences to produce textual descriptions. As a result, automatic extraction of human-like captions for a normalized input 3D pose is realized. Additionally, since the process is randomized, several descriptions per pose can be generated, as different human annotators would do.

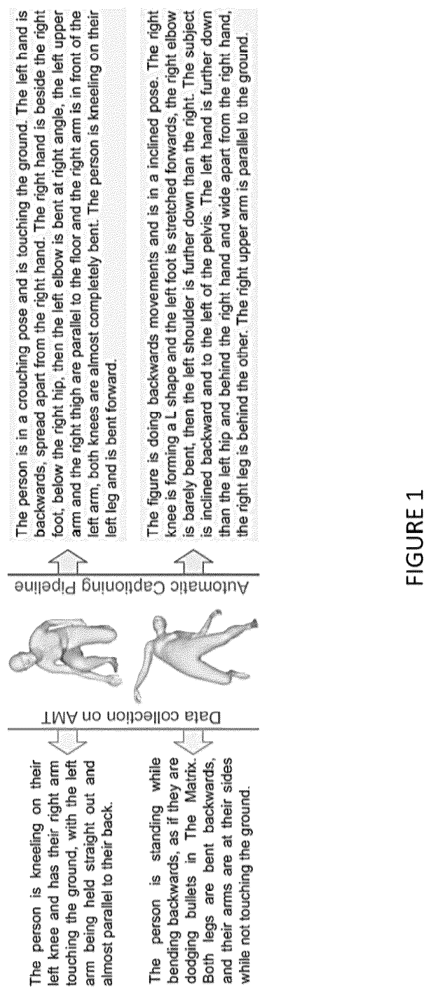

FIG. 1 shows examples of human-written and automatic captions. As illustrated in FIG. 1, examples of pose descriptions from PoseScript, produced by human annotators are shown on the left for the poses shown in the middle. Examples of pose descriptions from PoseScript produced by the automatic captioning pipeline are shown on the right for the poses shown in the middle.

Using the PoseScript dataset, as noted above and illustrated in FIG. 6, a cross-modal retrieval task can be performed where the goal is, given a text query, to retrieve the most similar poses in a database. Note that this can also be applied to RGB images by associating them with 3D human fits. Also, using the PoseScript dataset, as noted above and illustrated in FIG. 7, a second task can be performed consisting of generating human poses (e.g., of a 3D model of the human body exhibiting a pose) conditioned on a textual description. Conventional models have used attributes as semantic-level representation to edit body shapes or image faces. In contrast, the method and system, described below, focuses on body poses and leverages natural language, which has the advantage of being unconstrained and more flexible. For example, one conventional method focuses on generating human 2D poses, SMPL parameters or even images from captions. However, the captions, which are generally simple image-level statements on the activity performed by the human, and that sometimes account for the interaction with other elements from the scene, e.g. ‘A soccer player is running while the ball is in the air.’

In contrast, the method and system, described below, focuses on fine-grained detailed captions about the pose only (e.g., are not dependent on the activity of the scene in which a pose is taking place).

Another conventional method provides manually annotated captions about the difference between human poses in two synthetic images, wherein the captions mention objects from the environment such as ‘carpet’ or ‘door.’ A further conventional method automatically generates text about the discrepancies between a reference motion and a performed one, based on differences of angles and positions.

In contrast, the method and system, described below, focuses on describing one single pose without relying on any other visual element.

The method and system, described below, focuses on static poses, whereas many conventional methods have essentially studied 3D action (sequence) recognition or text-based 2D or 3D motion synthesis and either condition their model on action labels or descriptions in natural language. However, even if motion descriptions effectively constrain sequences of poses, motion descriptions do not specifically inform about individual poses.

The method and system, described below, uses a captioning generation process that relies on posecodes that capture relevant information about the pose semantics. Posecodes are inspired from posebits where images showing a human are annotated with various binary indicators. This data is used to reduce ambiguities in 3D pose estimation.

Conversely, the method and system, described below, automatically extract posecodes from normalized 3D poses in order to generate descriptions in natural language. Ordinal depth can be seen as a special case of posebits, focusing on the depth relationship between two joints to obtain annotations on some training images to improve a human mesh recovery model by adding extra constraints.

Poselets can also be used as another way to extract discriminative pose information but poselets lack semantic interpretations.

In contrast to these semantic representations, the method and system, described below, generate pose descriptions in natural language, which have the advantage (a) of being a very intuitive way to communicate ideas, and (b) of providing greater flexibility.

In the method and system, described below, the PoseScript dataset differs from existing datasets in that it focuses on single 3D poses instead of motion and provides direct descriptions in natural language instead of simple action labels, binary relations, or modifying texts.

The PoseScript dataset, as described below, is composed of static 3D human poses, together with fine-grained semantic annotations in natural language. The PoseScript dataset is built using automatically generated captions.

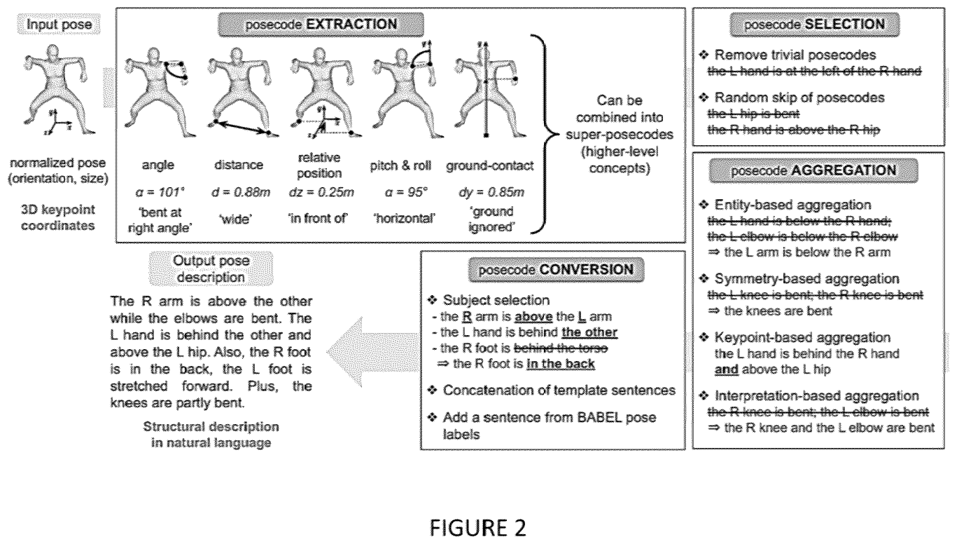

The process used to generate synthetic textual descriptions for 3D human poses (automatic captioning pipeline) is illustrated in FIG. 2. As illustrated in FIG. 2, the automatic captioning pipeline relies on the extraction, selection, and aggregation of elementary pieces of pose information, called posecodes, which are eventually converted into sentences to produce a description.

As illustrated in FIG. 2, given a normalized 3D pose, posecodes are used to extract semantic pose information. These posecodes are then selected, merged, or combined (when relevant) before being converted into a structural pose description in natural language. In FIG. 2, the letters ‘L’ and ‘R’ stand for ‘left’ and ‘right’ respectively.

The process, illustrated in FIG. 2, takes 3D keypoint coordinates of human-centric poses as input. These are inferred with the SMPL-H body model (i.e., a 3D (three dimensional) model of the human body based on skinning and blend shapes) using the default shape coefficients and a normalized global orientation along the y-axis.

With respect to the posecode extraction, as illustrated in FIG. 2, a posecode describes a relation between a specific set of joints. In one embodiment, the process captures for each specific set of joints five kinds of elementary relations: angles, distances and relative positions, but also pitch and roll and ground-contacts.

With respect to the posecode extraction, as illustrated in FIG. 2, angle posecodes describe how a body part ‘bends’ at a given joint, e.g. the left elbow. Depending on the angle, the posecode is assigned one of the following attributes: ‘straight’, ‘slightly bent’, ‘partially bent’, ‘bent at right angle’, ‘almost completely bent’ and ‘completely bent’.

With respect to the posecode extraction, as illustrated in FIG. 2, distance posecodes categorize the L2-distance between two keypoints (e.g. the two hands) into ‘close’, ‘shoulder width apart’, ‘spread’ or ‘wide’ apart.

With respect to the posecode extraction, as illustrated in FIG. 2, posecodes on relative position compute the difference between two keypoints along a given axis. The possible categories are, for the x-axis: ‘at the right of’, ‘x-ignored’, ‘at the left of’; for the y-axis: ‘below’, ‘y-ignored’, ‘above’; and for the z-axis: ‘behind’, ‘z-ignored’ and ‘in front of’. In particular, comparing the x-coordinate of the left and right hands allows to infer if they are crossed (i.e. the left hand is ‘at the right’ of the right hand). The ‘ignored’ interpretations are ambiguous configurations which will not be described.

With respect to the posecode extraction, as illustrated in FIG. 2, pitch & roll posecodes assess the verticality or horizontality of a body part defined by two keypoints; e.g., the left thigh is between the left knee and hip. A body part is ‘vertical’ if it is approximately orthogonal to the y-hyperplane, and ‘horizontal’ if it is in it. Other configurations are ‘pitch-roll-ignored’.

With respect to the posecode extraction, as illustrated in FIG. 2, ground-contact posecodes, used for intermediate computation only, denote whether a keypoint is ‘on ground’ (i.e. vertically close to the keypoint of minimal height in the body, considered as the ground) or ‘ground-ignored’.

Posecode categorizations are obtained using predefined thresholds. As these values are inherently subjective, the process randomizes the binning step by also defining a noise level applied to the measured angles and distances values before thresholding.

The process additionally defines a few super-posecodes to extract higher-level pose concepts. These posecodes are binary (they either apply or not to a given pose configuration) and are expressed from elementary posecodes. For instance, the super-posecode ‘kneeling’ can be defined as having both knees ‘on the ground’ and ‘completely bent’.

As utilized in FIG. 2, posecode selection aims at selecting an interesting subset of posecodes among those extracted, to obtain a concise yet discriminative description of the relations between joints. First, the process removes trivial settings (e.g., ‘the left hand is at the left of the right hand’). Next, the process randomly skips a few non-essential; i.e., non-trivial but non-highly discriminative; posecodes, to account for the natural oversights made by humans. Such posecodes are determined through a statistical study over the whole set of poses.

Also, the process sets highly-discriminative posecodes as unskippable.

As utilized in FIG. 2, posecode aggregation consists of merging posecodes that share semantic information. This reduces the size of the caption and makes it more natural. The process uses four aggregation rules.

The first rule is entity-based aggregation, which merges posecodes that have similar relation attributes while describing keypoints that belong to a larger entity (e.g. the arm or the leg). For instance, ‘the left hand is below the right hand’+‘the left elbow is below the right hand’ is combined into ‘the left arm is below the right hand’.

The second rule is symmetry-based aggregation which fuses posecodes that share the same relation attributes and operate on joint sets that differ only by their side of the body. The joint of interest is hence put in plural form, e.g., ‘the left elbow is bent’+‘the right elbow is bent’ becomes ‘the elbows are bent’.

The third rule is keypoint-based aggregation which brings together posecodes with a common keypoint. The process factors the shared keypoint as the subject and concatenates the descriptions. The subject can be referred to again using e.g. ‘it’ or ‘they’. For instance, ‘the left elbow is above the right elbow’+‘the left elbow is close to the right shoulder’+‘the left elbow is bent’ is aggregated into ‘The left elbow is above the right elbow, and close to the right shoulder. It is bent.’

The last rule is interpretation-based aggregation which merges posecodes that have the same relation attribute but applies to different joint sets (that may overlap). Conversely to entity-based aggregation, interpretation-based aggregation does not require that the involved keypoints belong to a shared entity. For instance, ‘the left knee is bent’+‘right elbow is bent’ becomes ‘the left knee and the right elbow are bent’.

Aggregation rules are applied at random when their conditions are met. In particular, joint-based and interpretation-based aggregation rules may operate on the same posecodes. To avoid favoring one rule over the other, merging options are first listed together and then applied at random.

As utilized in FIG. 2, posecode conversion into sentences is performed in two steps. First, the process selects the subject of each posecode. For symmetrical posecodes-which involve two joints that only differ by their body side—the subject is chosen at random between the two keypoints, and the other is randomly referred to by its name, its side or ‘the other’ to avoid repetitions and provide more varied captions. For asymmetrical posecodes, the process defines a ‘main’ keypoint (chosen as subject) and ‘support’ keypoints, used to specify pose information (e.g. the ‘head’ in ‘the left hand is raised above the head’). For the sake of flow, in some predefined cases, the process omits to name the support keypoint (e.g. ‘the left hand is raised above the head’ is reduced to ‘the left hand is raised’).

Second, the process combines all posecodes together in a final aggregation step. The process obtains individual descriptions by plugging each posecode information into one template sentences, picked at random in the set of possible templates for a given posecode category.

Finally, the process concatenates the pieces in random order, using random pre-defined transitions. Optionally, for poses extracted from annotated sequences in BABEL, the process adds a sentence based on the associated high-level concepts (e.g. ‘the person is in a yoga pose’).

Some automatic captioning examples are presented in FIG. 1 (right side). The captioning process is highly modular; it allows simply defining, selecting, and aggregating of the posecodes based on different rules. Design of new kinds of posecodes (especially super-posecodes) or additional aggregation rules, can yield further improvements. Randomization has been included at each step of the pipeline which makes it possible to generate different captions for the same pose, as a form of data augmentation.

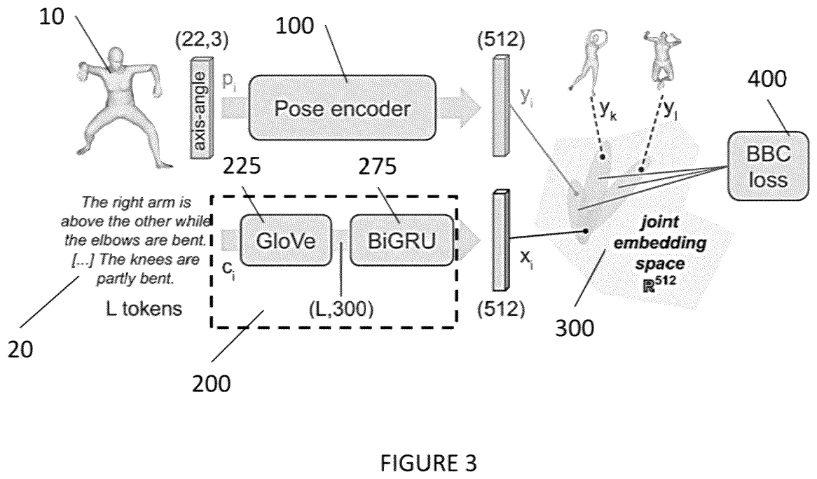

FIG. 3 illustrates an overview of a training scheme of a retrieval model. As illustrated in FIG. 3, the input pose 10 and caption 20 are fed to a pose encoder 100 and a text encoder 200, respectively, to map them into a joint embedding space 300. The loss 400 encourages the pose embedding yᵢ and its caption embedding xᵢ to be close in this latent space 300, while being pulled apart from features of other poses in the same training batch (e.g. yₖ and yₗ).

For text-to-pose retrieval, which consists in ranking a large collection of poses by relevance to a given textual query (and likewise for pose-to-text retrieval), it is standard to encode the multiple modalities into a common latent space.

Let S={(cᵢ, pᵢ)}^{N}ᵢ₌₁ be a set of caption-and-pose pairs. By construction, pᵢ is the most relevant pose for caption cᵢ, which means that p_{j≠i} should be ranked after pᵢ for text-to-pose retrieval. In other words, the retrieval model aims to learn a similarity function s(c, p)∈R such that s(cᵢ, pᵢ)>s(cᵢ, p_{j≠i}). As a result, a set of relevant poses can be retrieved for a given text query by computing and ranking the similarity scores between the query and each pose from the collection (the same goes for pose-to-text retrieval).

Since poses (e.g., 3D models of the human body exhibiting poses) and captions (e.g., text captions of describing poses of the human body) are from two different modalities, the process first uses modality-specific encoders to embed the inputs into a joint embedding space, where the two representations will be compared to produce the similarity score.

Let θ(·) and ϕ(·) be the textual and pose encoders respectively. The process denotes as x=θ(c)∈R^{d} and y=ϕ(p)∈R^{d} the L2-normalized representations of a caption c and of a pose p in the joint embedding space, as illustrated in FIG. 3.

As illustrated in FIG. 3, the tokenized caption 20 is embedded by a bi-GRU 275 mounted on top of pre-trained GloVe word embeddings 225.

The pose 10 is first encoded as a matrix of size (22, 3), consisting of the rotation of the main 22 body joints in axis-angle representation. The pose is then flattened and fed as input to the pose encoder 100; e.g., a VPoser encoder; consisting of a 2-layer MLP with 512 units, batch normalization and leaky-ReLU, followed by a fully-connected layer of 32 units. The process adds a ReLU and a final projection layer, in order to produce an embedding of the same size d as the text encoding.

For training, given a batch of B training pairs (xᵢ, yᵢ), the process uses the Batch-Based Classification (BBC) loss (400), which is common in cross-modal retrieval.

$${ℒ}_{BBC} = - \frac{1}{B} {\sum }_{i = 1}^{B} log \frac{exp ( γ σ ( {x}_{i} , {y}_{i} ) )}{{\sum }_{j} exp ( γ σ ( {x}_{i} , {y}_{j} ) )} ,$$

where γ is a learnable temperature parameter and σ is the cosine similarity function σ(x, y)=x^{T}y/(∥x∥₂×∥y∥₂).

In implementing the training, the training used embeddings of size d=512 and an initial loss temperature of γ=10. GloVe word embeddings are 300-dimensional. The model was trained end to end for 120 epochs, using Adam, a batch size of 32 and an initial learning rate of 2.10⁻⁴ with a decay of 0.5 every 10 epochs.

Text-to-pose retrieval was evaluated by ranking the whole set of poses for each of the query texts. The recall@K (R@K), which is the proportion of query texts for which the corresponding pose is ranked in the top-K retrieved poses, was then computed. The pose-to-text retrieval was evaluated in a similar manner. K=1, 5, 10 was used and additionally report the mean recall (mRecall) as the average over all recall@K values from both retrieval directions.

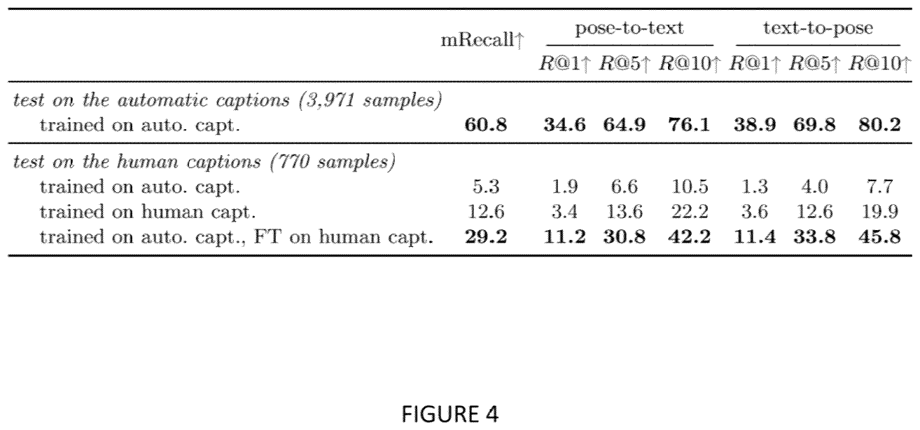

The results on the test set of PoseScript are illustrated in the table of FIG. 4 both on automatic and human-written captions only. As shown in the table, the model trained on automatic captions obtains a mean recall of 60.8%, with a R@1 above one third and a R@10 above 75% on automatic captions. However, the performance degrades on human captions, as many words from the richer human vocabulary are unseen during training on automatic captions.

When trained on human captions, the model obtains a higher—but still rather low—performance. Using human captions to finetune the initial model trained on automatic ones brings an improvement of a factor 2 and more, with a mean recall (resp. R@10 for text-to-pose) of 29.2% (resp. 45.8%) compared to 12.6% (resp. 19.9%) when training from scratch.

The evaluation shows the benefit of using the automatic captioning pipeline to scale-up the PoseScript dataset. In particular, the model is able to derive new concepts in human-written captions from non-trivial combination of existing posecodes in automatic captions.

With respect to text-conditioned human pose generation, i.e., generate possible matching poses for a given text query, the model is a pose encoder which in one embodiment is based on Variational Auto-Encoders (VAEs).

With respect to training, the process generates a pose \dot{p} given its caption c. To this end, a conditional variational auto-encoder model is trained by taking a tuple (p, c) composed of a pose p and its caption c, at training.

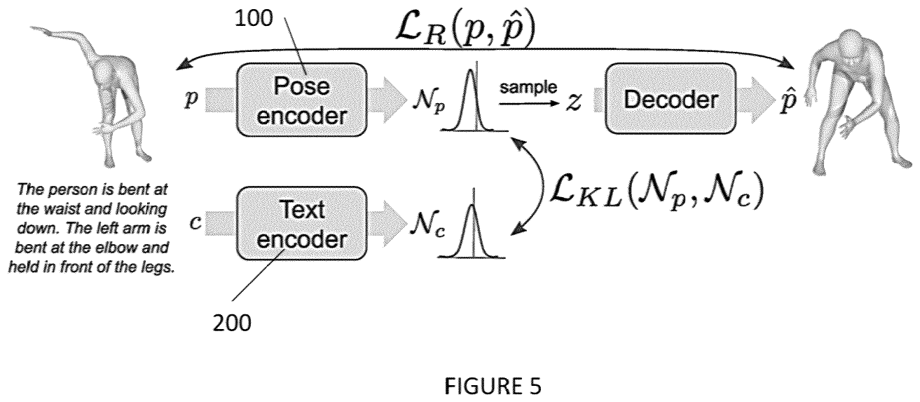

FIG. 5 illustrates an overview of the training model. As illustrated in FIG. 5, a pose encoder 100 maps the pose p to a posterior over latent variables by producing the mean μ(p) and variance Σ(p) of a normal distribution Nₚ=N(·|μ(p), Σ(p)).

Another encoder 200 is used to obtain a prior distribution independent of p but conditioned on c, N_{c}. A latent variable z˜Nₚ is sampled from Nₚ, and decoded into a generated sample pose \dot{p}. The training loss function combines a reconstruction term L_{R}(p, \dot{p}) between the original pose p and the generated pose \dot{p} and a regularization term, the Kullback-Leibler (KL) divergence between Nₚ and the prior given by N_{c}:

$$L = {L}_{R} ( p , \dot{p} ) + {L}_{KL} ( {N}_{p} , {N}_{c} ) .$$

As illustrated in FIG. 5, during training, the process follows a variational auto-encoder (VAE) but where the latent distribution Nₚ from the pose encoder has a KL divergence term with the prior distribution N_{c} given by the text encoder. At test time, the sample z is drawn from the distribution N_{c}. To sample from the model at test time, a caption c is encoded into N_{c}, from which z is sampled and decoded into a generated pose \dot{p}.

In training, the models use Adam optimizer with a learning rate of 10⁻⁴ and a weight decay of 10⁻⁴. The process follows VPoser for the pose encoder and decoder architectures and uses the same text encoder as in the retrieval training. The latent space has dimension 32.

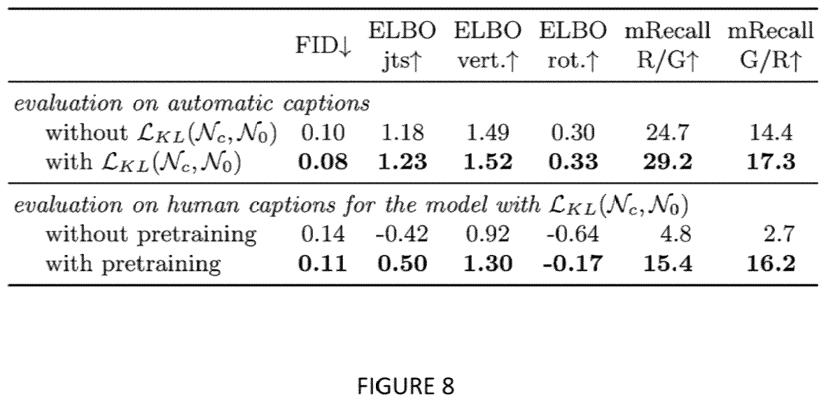

FIG. 8 illustrates a table showing evaluation of the text-conditioned generative model on automatic captions for a model without or with L_{KL}(N_{c}, N₀) (top) and on human captions without or with pre-training on the automatic captions (bottom). For comparison, the mRecall obtained when training and testing on real poses is 60.8 with automatic captions and 29.2 on human captions.

With respect to the table in FIG. 8, initially the impact of adding the extra-regularization loss L_{KL}(N_{c}, N₀) to the model when training and evaluating on automatic captions was studied. It was observed that it improves all metrics, in terms of FID, ELBO or mRecall retrieval metrics.

This configuration was kept and evaluated on human captions (a) when training on human captions and (b) when first pre-training on automatic captions and then finetuning on human captions. It was observed that the pre-training improves all metrics. In particular, the retrieval training/testing and the ELBOs improve substantially which shows that the pre-training helps to yield more realistic and diverse samples.

In the above-described embodiments, angle posecodes describe how a body part ‘bends’ around a joint j. Let a set of keypoints (i, j, k) where i and k are neighboring keypoints to j—for instance left shoulder, elbow and wrist respectively—and let pl denote the position of keypoint I. The angle posecode is computed as the cosine similarity between vectors vji=pi−pj and vjk=pk−pj.

Moreover, in the above-described embodiments, distance posecodes rate the L2-distance ∥vij∥ between two keypoints i and j.

Additionally, in the above-described embodiments, posecodes on relative position compute the difference between two sets of coordinates along a specific axis, to determine their relative positioning. A keypoint i is ‘at the left of’ another keypoint j if p^{x}ᵢ>p^{x}ⱼ; it is ‘above’ it if py i>p^{y}ⱼ; and ‘in front of’ it if p^{z}ᵢ>p^{z}ⱼ.

Furthermore, in the above-described embodiments, pitch & roll posecodes assess the verticality or horizontality of a body part defined by two keypoints i and j. A body part is said to be ‘vertical’ if the cosine similarity between vij l_∥vij∥ and the unit vector along the y-axis is close to 0. A body part is said to be ‘horizontal’ if it is close to 1.

Lastly, in the above-described embodiments, ground-contact posecodes can be seen as specific cases of relative positioning posecodes along the y axis. Ground-contact posecodes help determine whether a keypoint i is close to the ground by evaluating p^{y}i−minⱼ p^{y}ⱼ. As not all poses are semantically in actual contact with the ground, the process does not resort to these posecodes for systematic description, but solely for intermediate computations, to further infer super-posecodes for specific pose configurations.

As described above, each type of posecode is first associated to a value v (a cosine similarity angle or a distance), then binned into categories using predefined thresholds. In practice, hard deterministic thresholding is unrealistic as two different people are unlikely to always have the same interpretation when the values are close to category thresholds, e.g. when making the distinction between ‘spread’ and ‘wide’. Thus, the categories are inherently ambiguous and to account for this human subjectivity, the process randomizes the binning step by defining a tolerable noise level η_{τ} on each threshold τ.

The process then categorizes the posecode by comparing v+∈ to τ, where ∈ is randomly sampled in the range [−η_{τ}, η_{τ}]. Hence, a given pose configuration does not always yield the exact same posecode categorization.

Super-posecodes are binary and are not subject to the binning step. Super-posecodes only apply to a pose if all of the elementary posecodes, they are based on, possess the respective required posecode categorization.

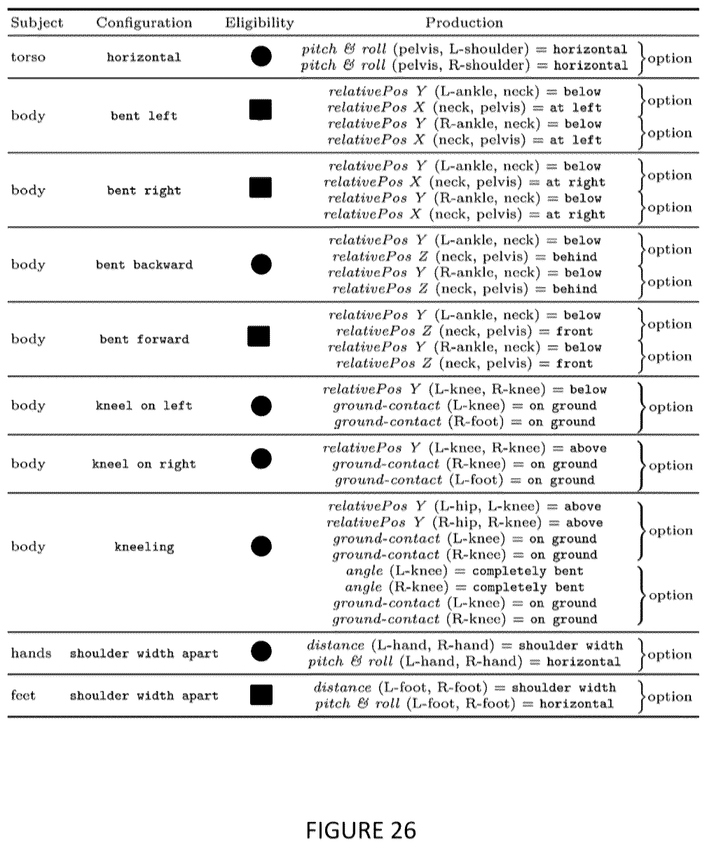

FIG. 26 illustrates a table showing a list of super-posecodes. For each super-posecode, the table indicates which body part(s) are subject to description and their corresponding pose configuration (each super-posecode is given a unique category). The table additionally specifies whether the associated posecode is skippable for description. The filled in circle represents an unskippable posecode and the filled in square represents a skippable posecode.

The last column explains the different options for the super-posecode to be produced (an option is represented by a set of elementary posecodes with their required categorization). Letters ‘L’ and ‘R’ stand for ‘left’ and ‘right,’ respectively.

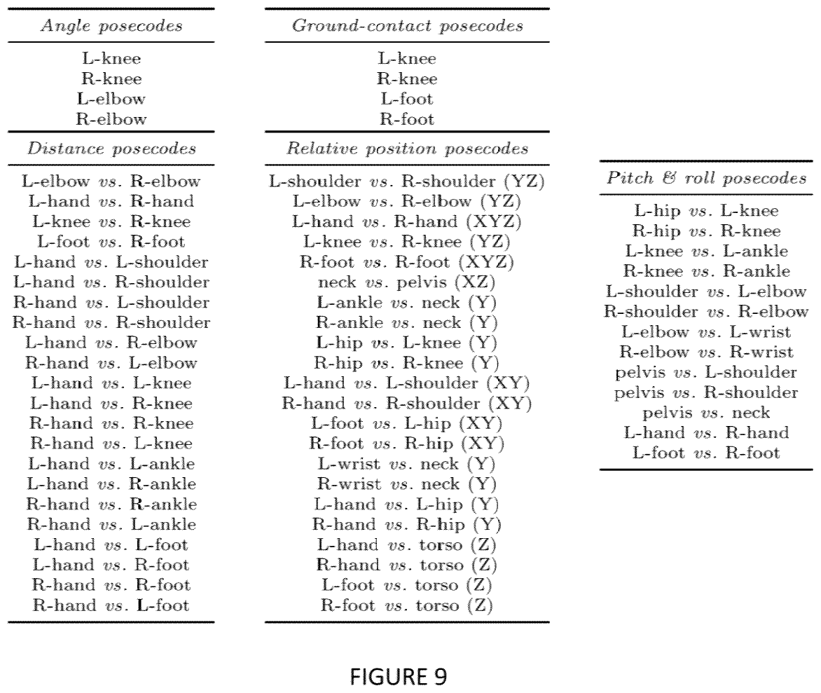

FIG. 9 provides a table listing the elementary posecodes that are used the above-described embodiments. The list includes 4 angle posecodes, 22 distance posecodes, 34 posecodes describing relative positions (7 along the x-axis, 17 along the y-axis and 10 along the z-axis), 13 pitch & roll posecodes and 4 ground-contact posecodes.

The table provides the keypoints involved in each of the posecodes. The posecodes on relative positions are grouped for better readability, as some keypoints are studied along several axes (considered axes are indicated in parenthesis). Letters ‘L’ and ‘R’ stand for ‘left’ and ‘right,’ respectively.

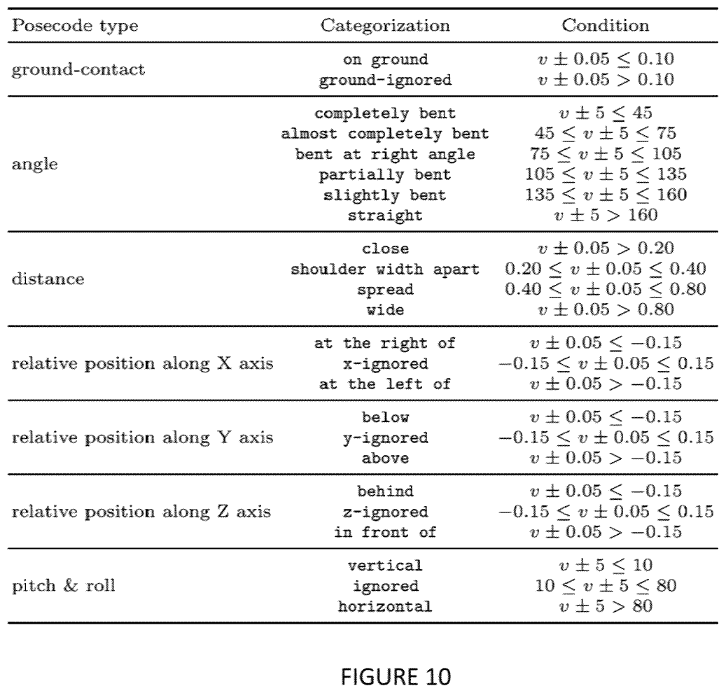

FIG. 10 illustrates a table of conditions for posecode categorizations. The right column provides the condition for a posecode to have the categorization indicated in the middle column. v represents the estimated value (an angle converted in degrees, or a distance in meters), while the number after the +denotes the maximum noise value that can be added to v. Thresholds and noise levels depend only on the type of posecode.

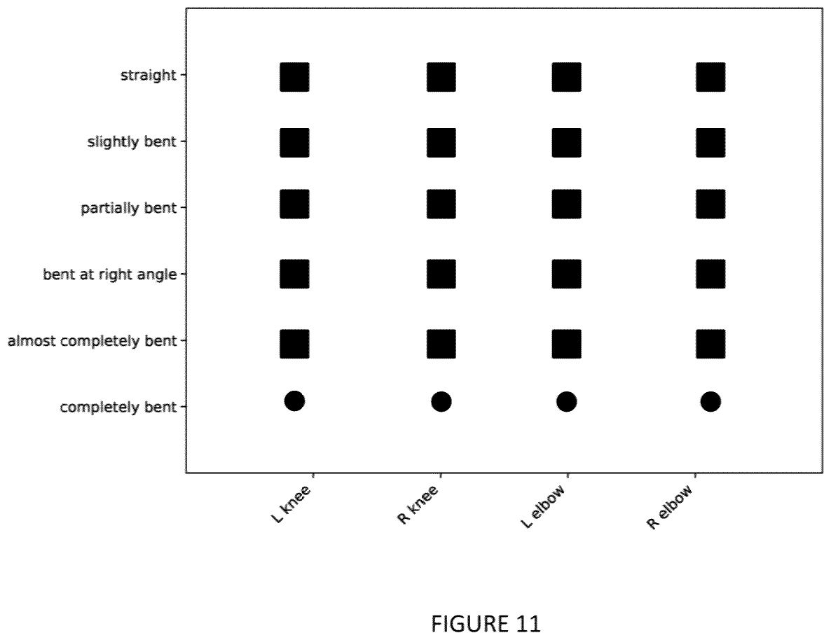

FIG. 11 illustrates angle posecode categorizations used at captioning time. Letters ‘L’ and ‘R’ refer to left and right body parts, respectively. The filled in circle represents an unskippable angle posecode categorization and the filled in square represents a skippable angle posecode categorization.

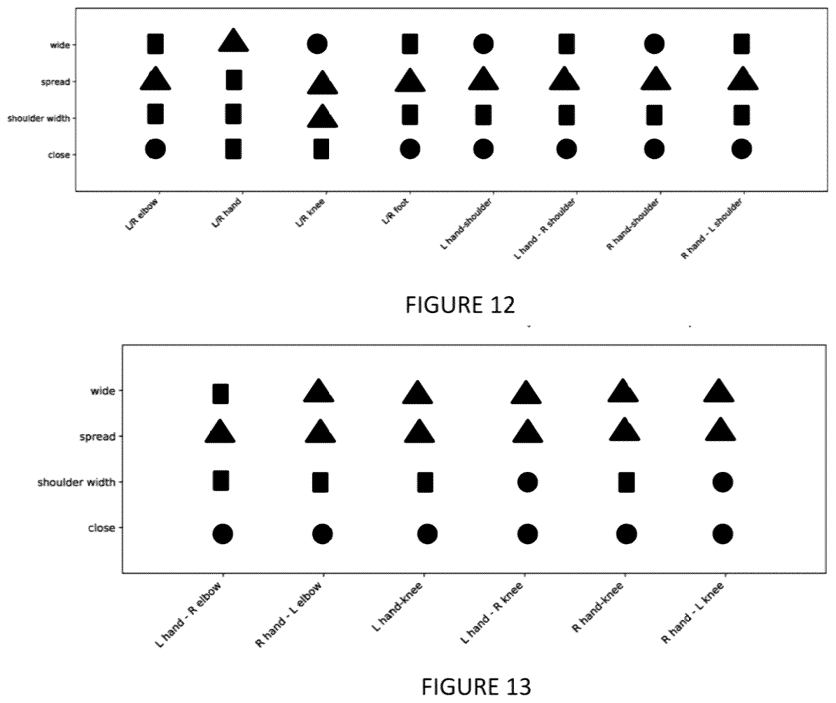

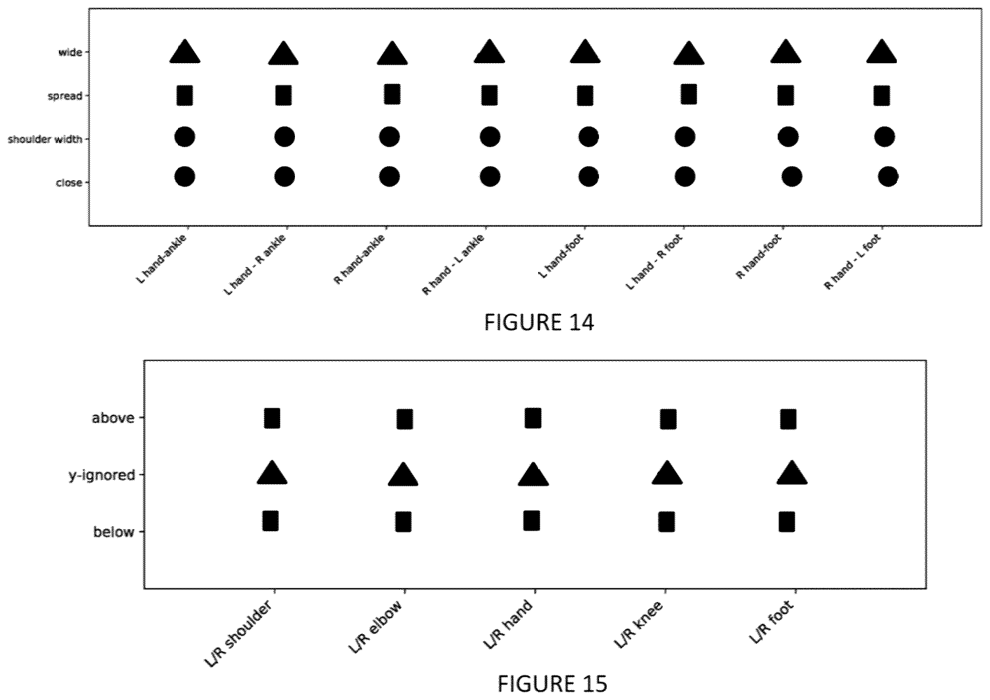

FIGS. 12 through 14 illustrate distance posecode categorizations used at captioning time. Letters ‘L’ and ‘R’ refer to left and right body parts, respectively. The filled in circle represents an unskippable distance posecode categorization, the filled in square represents a skippable distance posecode categorization, and the filled in triangle represents an ignored distance posecode categorization.

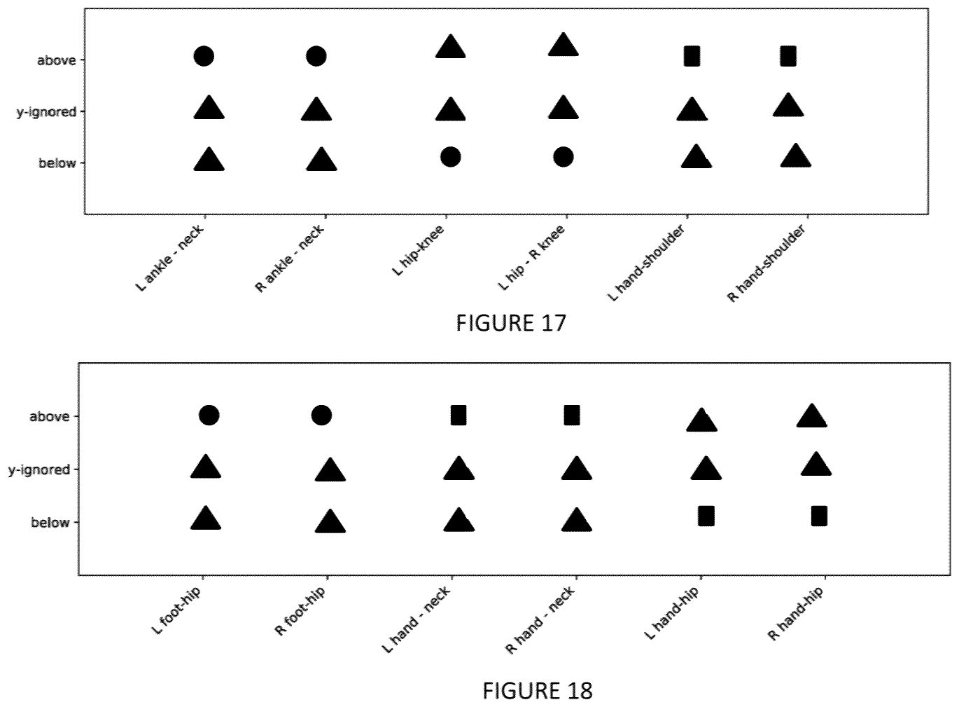

FIGS. 15, 17, and 18 illustrate relative position posecode categorizations along the y-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

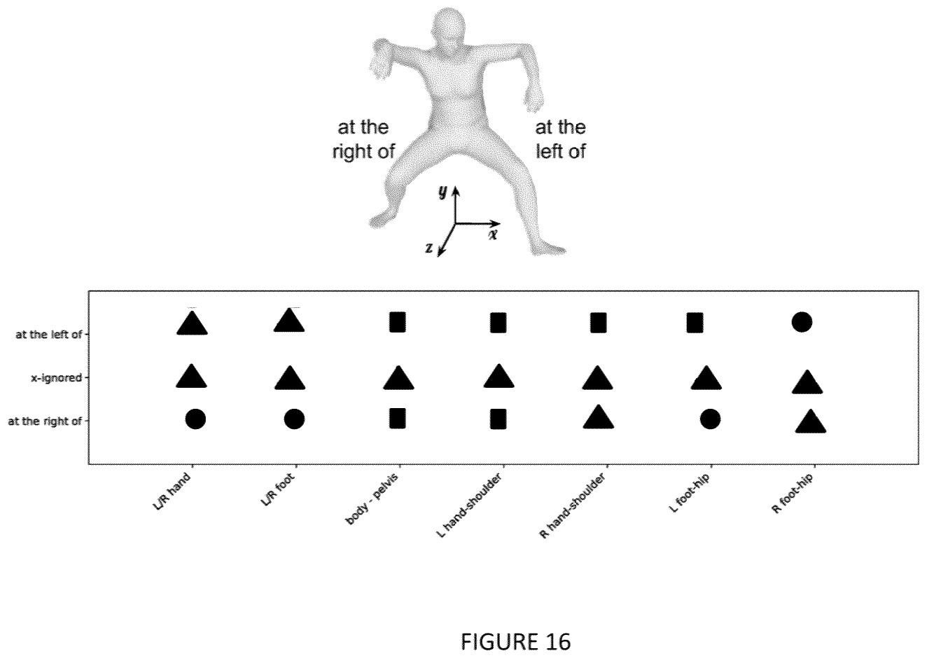

FIG. 16 illustrates relative position posecode categorizations along the x-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

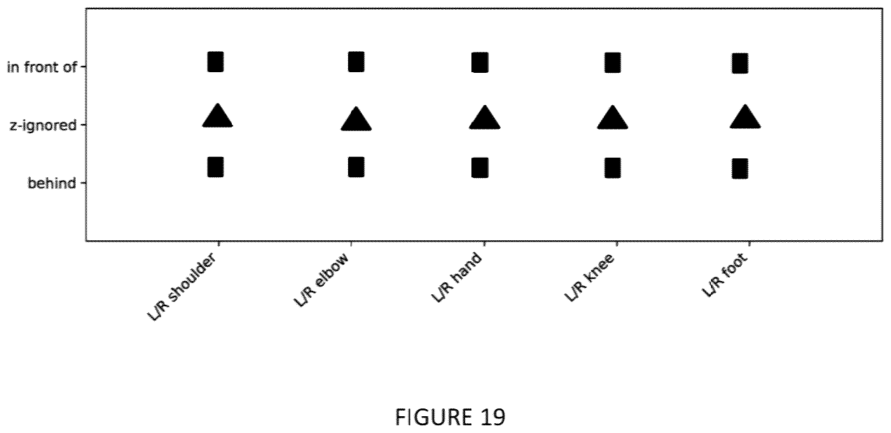

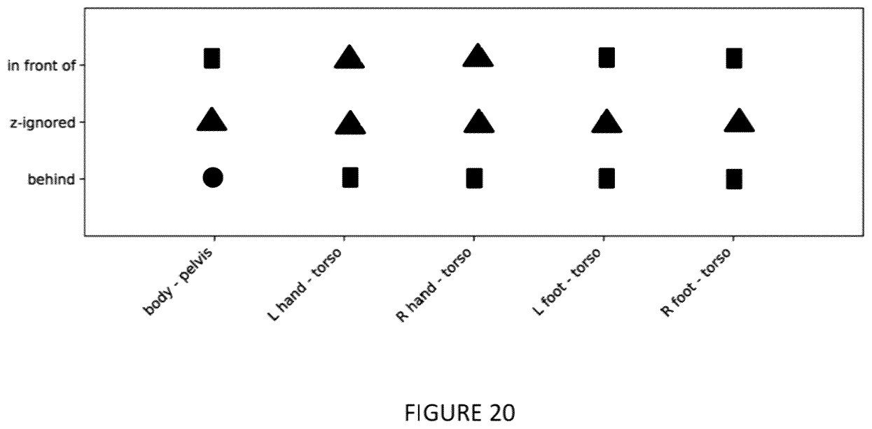

FIGS. 19 and 20 illustrate relative position posecode categorizations along the z-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

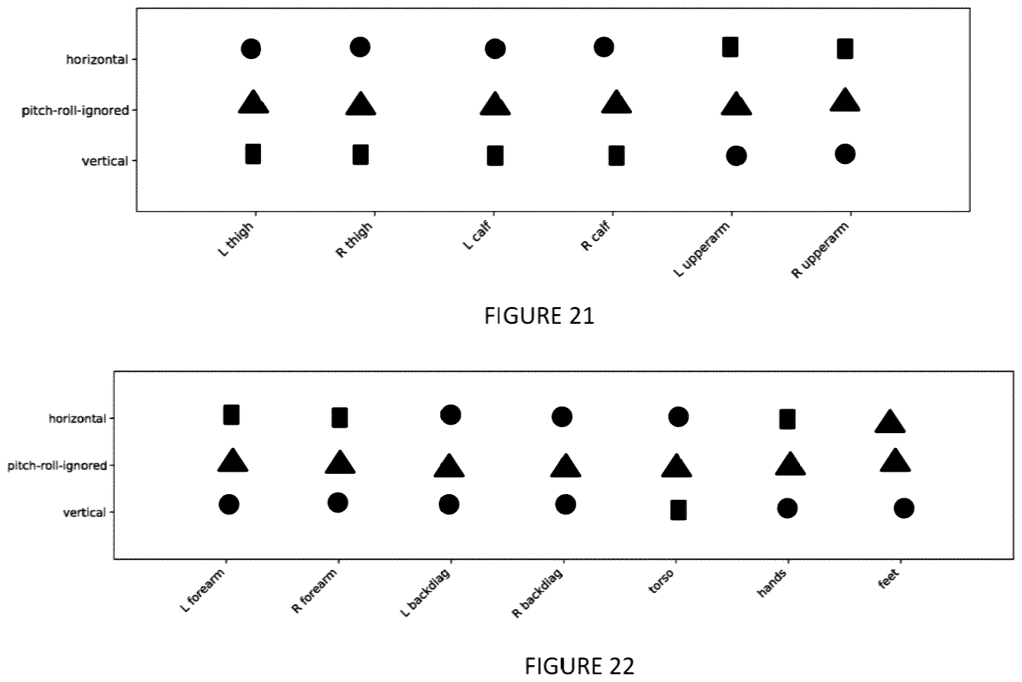

FIGS. 21 and 22 illustrate pitch & roll posecode categorizations. Letters ‘L’ and ‘R’ refer to left and right body parts, respectively. The filled in circle represents an unskippable pitch & roll posecode categorization, the filled in square represents a skippable pitch & roll posecode categorization, and the filled in triangle represents an ignored pitch & roll posecode categorization.

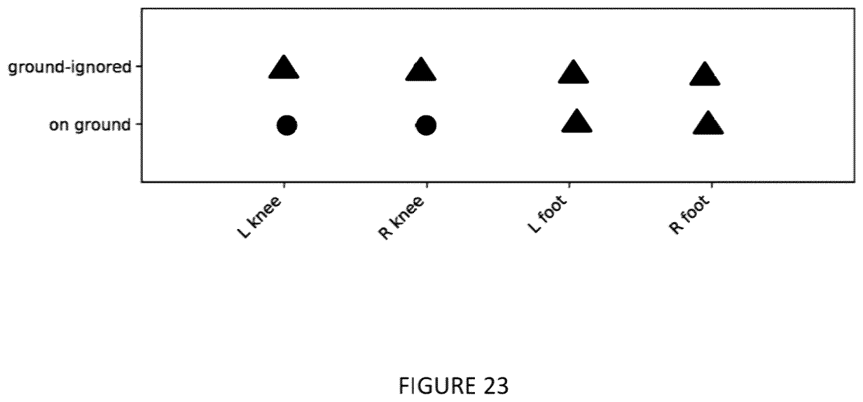

FIG. 23 illustrates ground-contact posecode categorizations. Letters ‘L’ and ‘R’ refer to left and right body parts, respectively. The filled in circle represents an unskippable ground-contact posecode categorization, the filled in square represents a skippable ground-contact posecode categorization, and the filled in triangle represents an ignored ground-contact posecode categorization.

The following is an explanation of a process used to generate 5 automatic captions for each pose and report retrieval performance when pre-training on each of them and evaluating on human-written captions. The explanation will also include statistics about the captioning process and provide additional information about certain steps of the captioning process.

In the process, all 5 captions, for each pose, were generated with the same pipeline. However, in order to propose captions with slightly different characteristics, some steps of the process were disabled when producing the different versions. Specifically, steps that were deactivated include (1) randomly skipping eligible posecodes for description; (2) adding a sentence constructed from high-level pose annotations given by BABEL; (3) aggregating posecodes; (4) omitting support keypoints (e.g. ‘the right foot is behind the torso’ does not turn into ‘the right foot is in the back’ when this step is deactivated); and (5) randomly referring to a body part by a substitute word (e.g. ‘it’/‘they’, ‘the other’).

To ease the impact of each step, the process is defined, using ‘simplified captions,’ as a variant of the procedure in which none of the last 3 steps were applied during the generation process.

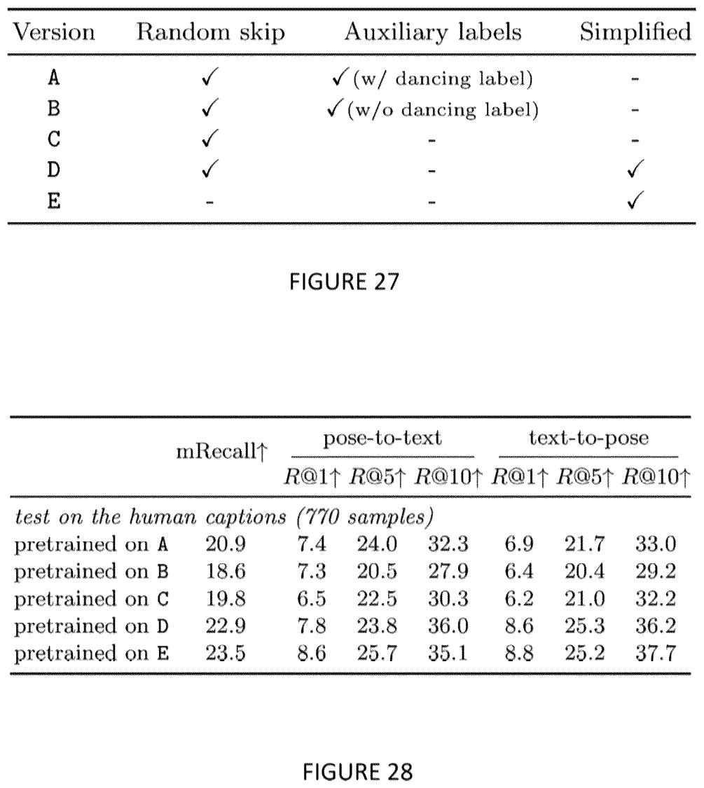

Among all the poses of PoseScript, only 6,628 poses are annotated in BABEL and may benefit from an additional sentence in their automatic description. As 39% of PoseScript poses come from DanceDB, which was not annotated in BABEL, the process additionally assigns the ‘dancing’ label to those DanceDB-originated poses, for one variant of the automatic captions that already leverages BABEL auxiliary annotations (See the table of FIG. 27). This resulted in 14,435 poses benefiting from an auxiliary label.

FIG. 27 illustrates a table showing a summary of the automatic caption versions. The V symbols indicate when characteristics apply to each caption version.

FIG. 28 illustrates a table showing the retrieval performance on human-written captions when pre-training a retrieval model on each automatic caption version separately, then fine-tuning the models on human-written captions before evaluation.

More specifically, the table of FIG. 28 shows text-to-pose and pose-to-text retrieval results on the test split of human-written captions from PoseScript dataset, when pre-training separately on each automatic caption version, then fine-tuning on human-written captions.

First, note that best retrieval results were obtained by pre-training on all five caption versions together (as illustrated in FIG. 4). It approximately obtains a 6 points improvement with respect to the best model trained on one single caption version.

Next, the impact of posecode aggregation and phrasing implicitness on retrieval performance is observed by comparing results obtained by pre-training either on caption version D or on caption version C. Both caption versions share the same characteristics, except that version D is ‘simplified’. This means that D captions do not contain pronouns such as ‘it’ and ‘the other’, which represent an inherent challenge in NLP, as a model needs to understand to which entity these pronouns refer.

Moreover, there is no omission of secondary keypoints (e.g. ‘the right foot is behind the torso’). Hence, D captions have much less phrasing implicitness than C captions (note that there is still implicit information in the simplified captions, e.g. ‘the right hand is close to the left hand’ implicitly involves some rotation at the elbow or shoulder level). In the table of FIG. 28, a mean-recall increase of 3% is observed when pre-training on D. This shows that aggregation and phrasing implicitness lead to more complex captions, as this is a source of error for cross-modal retrieval.

It is noted that the additional ‘dancing’ label for poses, originating from DanceDB, greatly helps (2.3 points improvement for A with respect to B). This may be because it makes it easier to distinguish between more casual poses (e.g. sitting) and highly various ones. Also, not using any BABEL label is better than using some, as evidenced by the 1.2 points difference between B and C.

This can be explained by the fact that less than 33% of PoseScript poses are provided a BABEL label, and that those are too diverse (some examples include ‘yawning’, ‘coughing’, ‘applauding’, ‘golfing’ . . . ) and too rare to robustly learn from. Many of these labels are motion labels and thus do not discriminate specific static poses. Finally, it is noted that slightly better performance is obtained when not randomly skipping posecodes, possibly because descriptions that are completer and more precise are beneficial for learning.

A number of ‘eligible’ posecode categorizations were extracted from the 20,000 poses over the different caption versions. During the posecode selection process, 42,857 of these were randomly skipped. In practice, a bit less than 6% of the posecodes (17,593) are systematically kept for captioning due to being statistically discriminative (unskippable posecodes).

All caption versions were generated together in less than 5 minutes for the whole PoseScript dataset. Since the pose annotation task usually takes 2-3 minutes, it means that 60 k descriptions can be generated in the time it takes to manually write one.

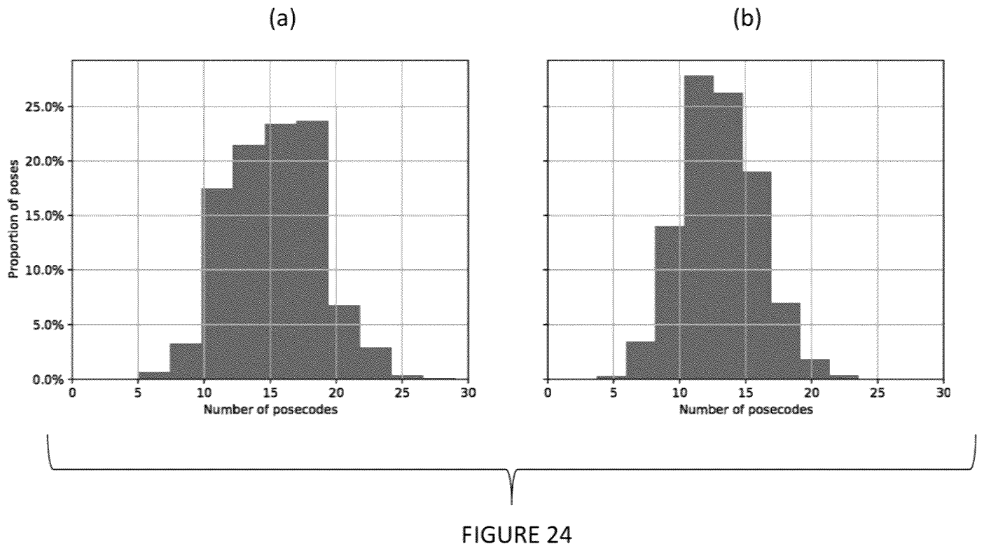

Histograms about the number of posecodes used to generate the captions are presented in FIG. 24. The histogram on the left presents the number of posecodes for the caption version E, which does not perform random skipping. The number of posecodes of each pose, in the right histogram, was averaged over the other 4 caption versions produced for it.

Automatic captions are based on an average number of 13.5 posecodes. Besides, it is noted that that less than 0.1% of the poses had the exact same set of 87 posecode categorizations than another.

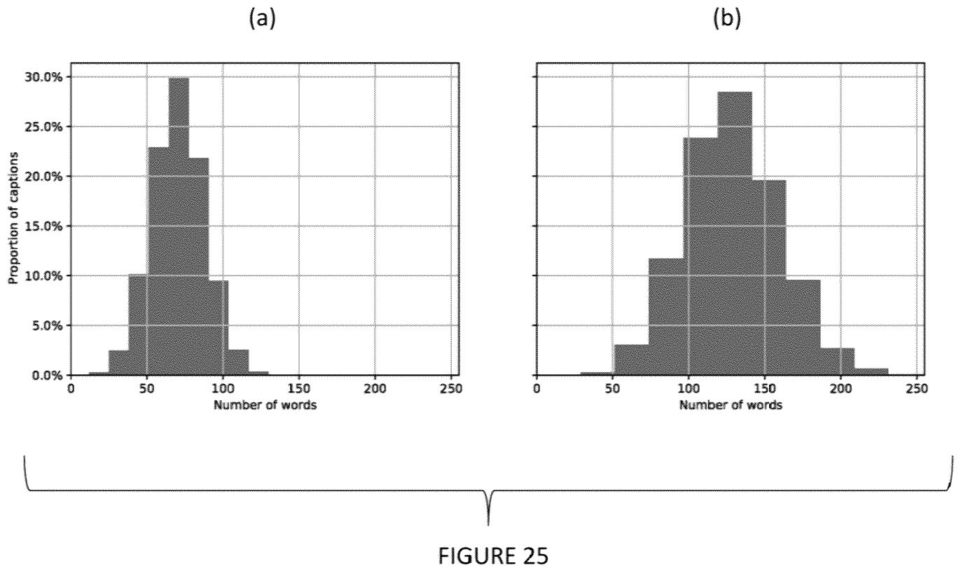

Histograms about the number of words per automatic caption are additionally shown in FIG. 25, for version C (left) and version E (right). The length difference can be explained by the fact that version C was obtained by randomly skipping some posecodes and generally aggregating them. Version C captions are assumed to be closer to what humans would write.

Note that removal of redundant posecodes is not yet performed in the posecode selection step of our automatic captioning pipeline. The automatic captions are hence naturally longer than human-written captions.

The process takes 3D joint coordinates of human-centric poses as input. These are inferred using the neutral body shape with default shape coefficients and a normalized global orientation along the y-axis. The process uses the resulting pose vector of dimension N×3 (N=52 joints for the SMPL-H model), augmented with a few additional keypoints, such as the left/right hands and the torso. They are deduced by simple linear combination of the positions of other joints and are included to ease retrieval of pose semantics (e.g. a hand is in the back if it is behind the torso).

Specifically, the hand keypoint is computed as the center between the wrist keypoint and the keypoint corresponding to the second phalanx of the hand's middle finger; and the torso keypoint is computed as the average of the pelvis, the neck, and the third spine keypoint.

For entity-based aggregation, two very simple entities are defined: the arm (formed by the elbow, and either the hand or the wrist; or by the upper-arm and the forearm) and the leg (formed by the knee, and either the foot or the ankle; or by the thigh and the calf).

With respect to omitting support keypoints, the process omits the second keypoint in the phrasing in those specific cases: a body part is compared to the torso, the hand is found ‘above’ the head, and the hand (resp. foot) is compared to its associated shoulder (resp. hip) and is found either cat the left of′ or cat the right of′ of it. For instance, better than having ‘the right hand is at the left of the left shoulder’, which is quite tiresome; e.g., would have ‘the right hand is turned to the left’.

In addition to generating dataset using an automatic process as discussed above, a portion of the dataset can be built using a human intelligence task wherein a person provides a written description of a given pose that is accurate enough to for the pose to be identified, based upon pose discriminators, from the other similar poses.

To select the pose discriminators for a given pose to be annotated, the pose discriminator for a given pose is compared to the other poses of PoseScript. Similarity between the poses is measured using the distance between their pose embeddings, with an early version of the retrieval model.

In one embodiment, discriminators may be the closest poses, while having at least twenty different posecode categorizations. This ensures that the selected poses share some semantic similarities with the pose to be annotated while having sufficient differences to be easily distinguished by the human annotator.

A generated annotation for a human pose is used when nearly all the body parts are described; there is no left/right confusion; the description refers to a static pose, and not to a motion; there is no distance metric; and there is no subjective comment regarding the pose.

Another application of natural language and pose generation may be automatically generating movement instructions, for a fitness application, based on a comparison between a gold standard fitness pose and the pose of user, exercising in front of their smartphone camera in their living room. An example of a movement instruction could be “straighten your back.

In another context, the feedback can be considered a modifying instruction, provided by a digital animation artist to automatically modify the pose of a character, without having to redesign everything by hand. This feedback could be some kind of constraint, to be applied to a whole sequence of poses; such as, “make them run, but with hands on the hips.” It could also be a hint, to guide pose estimation from images in failure cases: start from an initial three-dimensional body pose fit and give step-by-step instructions for the model to improve its pose estimation; such as, “the left elbow should be bent to the back.”

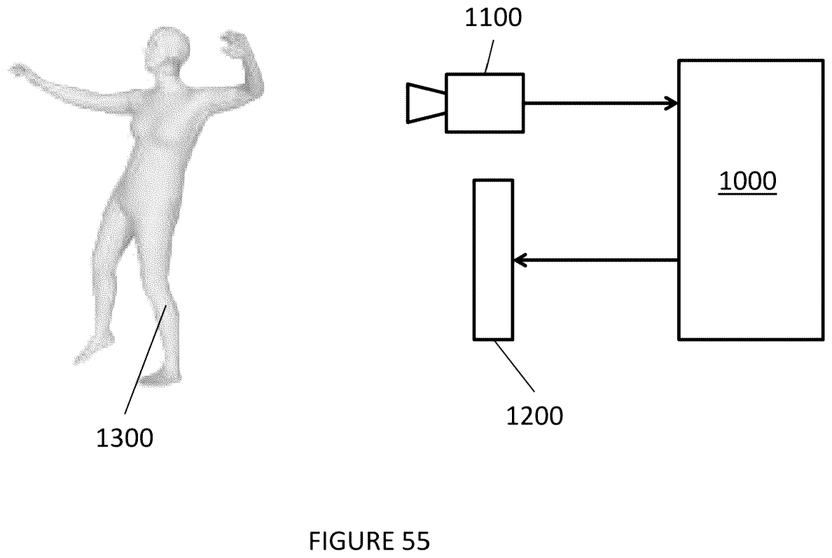

FIG. 55 illustrates an example of a system that utilizes the processes and models described below to provide feedback to a user to assist the user realize a desired pose. As illustrated in FIG. 55, a user 1300 attempts to strike a desired pose. An imaging device 1100 captures the pose and feeds the information to a processor 1000. An input/output device 1200 enables a user to input a desired pose, through a keyboard or a graphic user interface. The processor compares the captured user's pose with the desired pose, and based upon the comparison, generates natural language instructions to guide the user 1300 to the correct pose. These natural language instructions are conveyed to the input/output device 1200, such as a display and/or an audio device.

To realize this application, the process focuses on free-form feedback, which describes the change between two static 3D human poses (which can be extracted from actual pose sequences) because there exist many settings that require the semantic understanding of fine-grained changes of static body poses.

For instance, yoga poses are extremely challenging and specific (with a lot of subtle variations), and yoga poses are static. Some sport motions require almost-perfect postures at every moment: for better efficiency, to avoid any pain or injury, or just for better rendering; e.g., in classical dance, yoga, karate, etc. Additionally, the realization of complex motions sometimes calls for precise step-to-step instructions, in order to assimilate the gesture or to perform it correctly.

Natural language can help in all these scenarios, in that it is highly semantic and unconstrained, in addition to being a very intuitive way to convey ideas. However, while the link between language and images has been extensively studied in tasks like image captioning or image editing, the research on leveraging natural language for three-dimensional human modeling is still in its infancy. A few works use textual descriptions to generate motion, to describe the difference in poses from synthetic two-dimensional renderings or to describe a single static pose Nevertheless, there currently exists no dataset that associates pairs of three-dimensional poses with textual instructions to move from one source pose to one target pose.

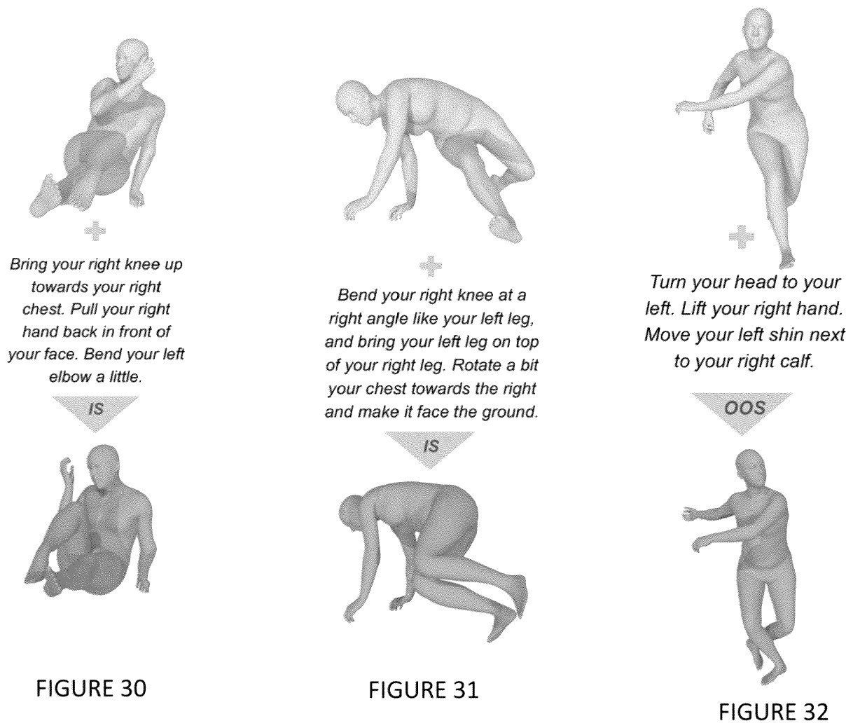

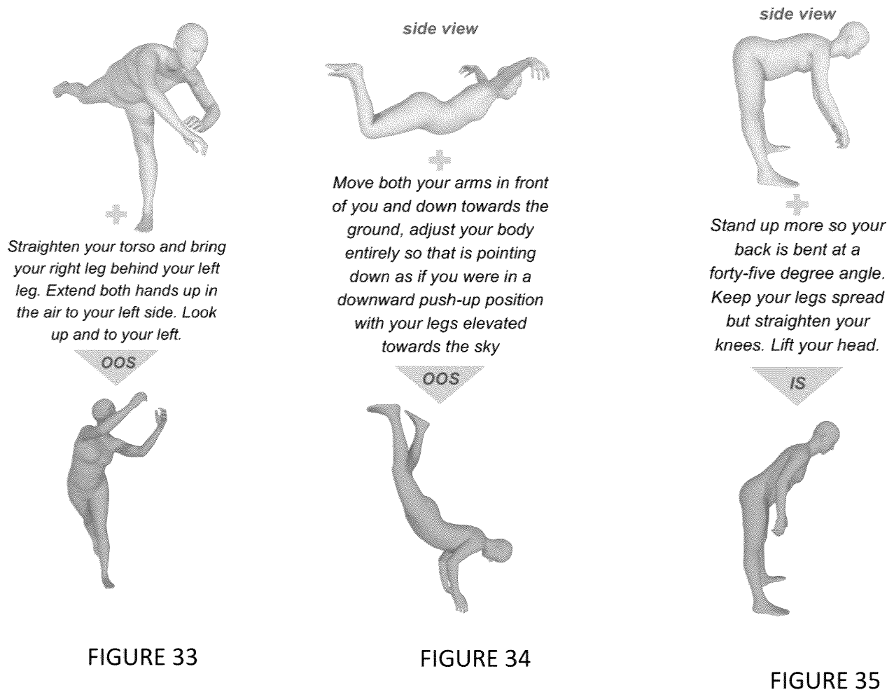

To address this issue, the process described below uses the PoseFix dataset which contains over 6,000 textual modifiers written by human annotators for this scenario. FIGS. 30-35 illustrates examples of textual modifiers written by human annotators. In FIGS. 30-35, the poses on top represent the source pose, while the poses on the bottom represent the target pose. IS means “in-sequence” and OOS means “out-of-sequence”; i.e., the source pose and the target pose come from the same sequence (IS) or not (OOS).

Leveraging the PoseFix dataset, two tasks can be realized: text-based pose editing, where the goal is to generate new poses from an initial pose and the modification instructions, and correctional text generation where the objective is to produce a textual modification instruction, based on the difference between a pair of poses. A process to produce “automatic modifiers” from an input pose pair, described below, is used to generate more data for pretraining the processes on the two forementioned tasks. This last process is called automatic comparative pipeline.

The automatic comparative pipeline generates modifiers based on the 3D key point coordinates of two input poses. The process relies on low-level properties. First, the process measures and classifies the variation of atomic pose configurations to obtain a set of “paircodes”. For instance, the process attends to the motion of the key points along each axis (“move the right hand slightly to the left” (x-axis), “lift the left knee” (y-axis)), to the variation of distance between two key points (“move your hands closer”) or to the angle change (“bend your left elbow”)

Next are defined “super-paircodes”, resulting from the combination of several paircodes or posecodes; e.g., the paircode “bend the left knee less”, associated to the posecode “the left knee is slightly bent” on pose A leads to the super-paircode “straighten the left leg”. The super-paircodes make it possible to describe higher-level concepts or to refine some assessments (e.g., only tell to move the hands farther away from each other if they are close to begin with)

The paircodes are next aggregated using the same set of rules as in the automatic captioning pipeline of FIG. 2, then the paircodes are semantically ordered, to gather information about the same general part of the body within the description, so as to make the modifiers easier to read and closer to what a human would write (i.e., describe about everything related to the right arm at once, instead of scattering pieces of information everywhere in the text)

This step does not exist in the PoseScript automatic pipeline. Specifically, a directed graph is designed, where the nodes represent the body parts and the edges define a relation of inclusion or proximity between them (e.g., torso→left shoulder, arm→forearm). For each pose pair is performed a randomized depth walk through the graph: starting from the body node, one node is chosen at random among the ones directly accessible, then the process is reiterated from that node until a leaf is reached; at that point, the process comes back to the last visited node leading to non-visited nodes and samples one child node at random. The order in which the body parts are visited is used to order the paircodes.

Ultimately, for each paircode, the process samples and completes one of the associated template sentences. Their concatenation, thanks to transition texts, yields the automatic modifier. Verbs are conjugated according to the chosen transition (e.g. “while+gerund”) and code (e.g. posecodes lead to “[ . . . ] should be” sentences) The whole process produced 135 k annotations in less than 15 minutes. This automatic data is used for pretraining only.

For the first task, a baseline consisting in a conditional Variational Auto-Encoder (cVAE) is used. For the second task, a baseline built from an auto-regressive transformer model is used.

With respect to three-dimensional pose and text datasets, AMASS gathers several datasets of three-dimensional human motions in SMPL format. BABEL and HumanML3D build on top of AMASS to provide free-form text descriptions of the sequences, similarly to the earlier and smaller Kit Motion-Language dataset. These datasets focus on sequence semantics (high level actions) rather than individual pose semantics (fine-grained egocentric relations).

To complement, PoseScript links static three-dimensional human poses with descriptions in natural language about fine-grained pose aspects. However, PoseScript does not make it possible to relate two poses together in a straightforward way, thus the use of the PoseFix dataset. In contrast to FixMyPose dataset, the PoseFix dataset comprehends poses from more diverse sequences and the textual annotations were collected based on actual three-dimensional data and not synthetic two-dimensional image renderings (reduced depth ambiguity).

With respect to three-dimensional human pose generation, previous works have mainly focused on the generation of pose sequences, conditioning on music, context, past poses, text labels, and mostly on text descriptions. Some works push it one step further and also attempt to synthesize the mesh appearance, leveraging large pre-trained models like CLIP.

Similarly to PoseScript, the processes, described below, depart from generic actions and focus on static poses and fine-grained aspects of the human body, to learn about precise egocentric relations. However, the processes, described below, consider two poses instead of one to comprehend detailed pose modifications. Different from ProtoRes, which proposes to manually design a human pose inside a three-dimensional environment based on sparse constraints, the processes, described below, use text for controllability. As PoseScript and VPoser, an (unconditioned) pose prior, the processes, described below, use a variational auto-encoder-based model to generate the three-dimensional human poses.

With respect to pose correctional feedback generation, recent advances in text generation have led to a shift from recurrent neural networks to large pre-trained transformer models, such as GPT These models can be effectively conditioned using prompting or cross-attention mechanisms While multi-modal text generation tasks, such as image captioning, have been extensively studied, no previous work has focused on using three-dimensional human poses to generate free-form feedback.

In this regard, AlFit extracts three-dimensional data to compare the video performance of a trainee against a coach and provides feedback based on predefined templates. Posecoach does not provide any natural language instructions, either. Besides, FixMyPose is based on highly-synthetic two-dimensional images.

Compositional learning consists in using a query made of multiple distinct elements, which can be of different modalities, as for visual question answering or composed image retrieval. Similarly, to the latter, the processes, described below, are interested in bi-modal queries composed of a textual “modifier” which specifies changes to apply on the first element. Modifiers first took the form of single-word attributes and evolved into free-form texts. While many works focus on text-conditioned image editing or text-enhanced image search, few study three-dimensional human body poses. ClipFace proposes to edit three-dimensional morphable face models and StyleGAN-Human generates two-dimensional images of human bodies in very model-like poses. PoseTutor provides an approach to highlight joints with incorrect angles on two-dimensional yoga/pilate/kung-fu images. More related to the processes, described below, FixMyPose performs composed image retrieval. Conversely, the processes, described below, propose to generate a three-dimensional pose based on an initial static pose and a modifier expressed in natural language.

To tackle the two pose correctional tasks, the processes, described below, use a dataset, Posefix, as noted above. The Posefix dataset consists of 6157 triplets of {pose A, pose B, text modifier}, where pose B (the target pose) is the result of the correction of pose A (the source pose), as specified by the text modifier.

The three-dimensional human body poses were sampled from AMASS and presented in pairs to annotators on the crowd-source annotation platform Amazon Mechanical Turk, in order to obtain textual descriptions in Natural Language.

Pose pairs can be of two types: “in-sequence” or “out-of-sequence.” In the first case, the two poses belong to the same AMASS sequence and are temporally ordered (pose A happens before pose B). The in-sequence pose pairs have a maximum time difference of half a second.

The in-sequence pose pairs used in the process yield textual modifiers describing precisely atomic motion sub-sequences and make it possible to have corresponding ground-truth motion. It is noted that for an increased time difference between the two poses, there could be an infinite number of plausible in-between motions, which would weaken a supervision signal. Out-of-sequence pairs are made of two poses from different sequences, to help generalize to less common motions and to study poses of similar configuration but different style, empowering “pose correction” beside “motion continuation”.

With respect to selecting pose B, the goal is to obtain pose B from pose A. The process considers that pose B is guiding most of the annotation: while the text modifier should account for pose A and refer to it, its true target is pose B. Hence, when building the triplets {pose A, pose B, text modifier}, the process starts choosing the set of poses B. In order to maximize the diversity of poses, the process gets a set S of 20000 poses sampled with a farthest-point algorithm. Poses B are then iteratively selected from S.

With respect to selecting pose A, for a pair to be considered, its pose A and pose B have to satisfy two main constraints. First, poses A and B have to be similar enough for the text modifier not to become a complete description of pose B. Note that if A and B are too different, it is more straightforward for the annotator to just ignore A and directly characterize B.

However, the process aims at learning fine-grained and subtle differences between two poses. To that end, the process ranks all poses in S with regard to each pose B based on the cosine similarity of their PoseScript semantic pose features. Pose A is to be selected within the top one hundred.

Second, the two poses should be different enough, so that the modifier does not collapse to oversimple instructions like ‘raise your right hand’, which would not compare to realistic scenarios.

While the poses can be assumed to be already quite different since they are all part of S, the process goes one step further and leverages posecode information to ensure that the two poses have at least 15 low-level different properties (e.g., joint angles or relative positions) for in-sequence pairs, and 20 for out-of-sequence pairs.

The process considers all possible in-sequence pairs A−+B, with A and B in S, which meet the selection constraint. Then, following the order defined by S, the process samples out-of-sequence pairs: for each selected pair A−+B, if A was not already used for another pair, the process also considers B−+A. These are called pairs ‘two-way’ pairs, as opposed to ‘one-way’ pairs. Two-way pairs can be used for cycle consistency.

With respect to dataset splits, the process uses a sequence-based train-validation-test split and performs pose pair selection independently in each one. As a result, all poses from the same sequence belong to the same split. Eventually, since the process uses the same ordered set S as PoseScript, the same poses can be annotated both with a description and a modifier, which makes complementary information to be used; e.g., in a multitask setting.

In performing the process, textual modifiers were collected on Amazon Mechanical Turk from English-speaking annotators who already completed at least 5000 tasks with a 95% approval rate. To limit perspective-based mistakes, the annotators were presented with both poses rendered under different viewpoints.

An annotation could not be submitted until more than 10 words and several viewpoints were considered. The orientation of the poses was normalized so the poses would both face the annotator in the front view. Only for in-sequence pairs, the normalization applied for pose A would also be applied to pose B, to stay faithful to the global change of orientation in the ground-truth motion sequences.

The annotators were given the following instruction: “You are a coach or a trainer. Your student is in pose A, but should be in pose B. Please write the instructions so the student can correct the pose on at least 3 aspects.” Annotators were required to describe the position of the body parts relatively to the others (e.g., ‘Your right hand should be close to your neck.’), to use directions (such as ‘left’ and ‘right’) in the subject's frame of reference and to mention the rotation of the body, if any. The annotators were also encouraged to use analogies (e.g., ‘in a push-up pose’). For the annotations to be scalable to any body size, distance metrics were not used.

As noted above, PoseFix contains 6157 annotated pairs, split according to a 70%-10%-20% proportion. In average, text modifiers are close to 30 words long with a minimum of 10 words. The text modifiers constitute a cleaned vocabulary of 1068 words.

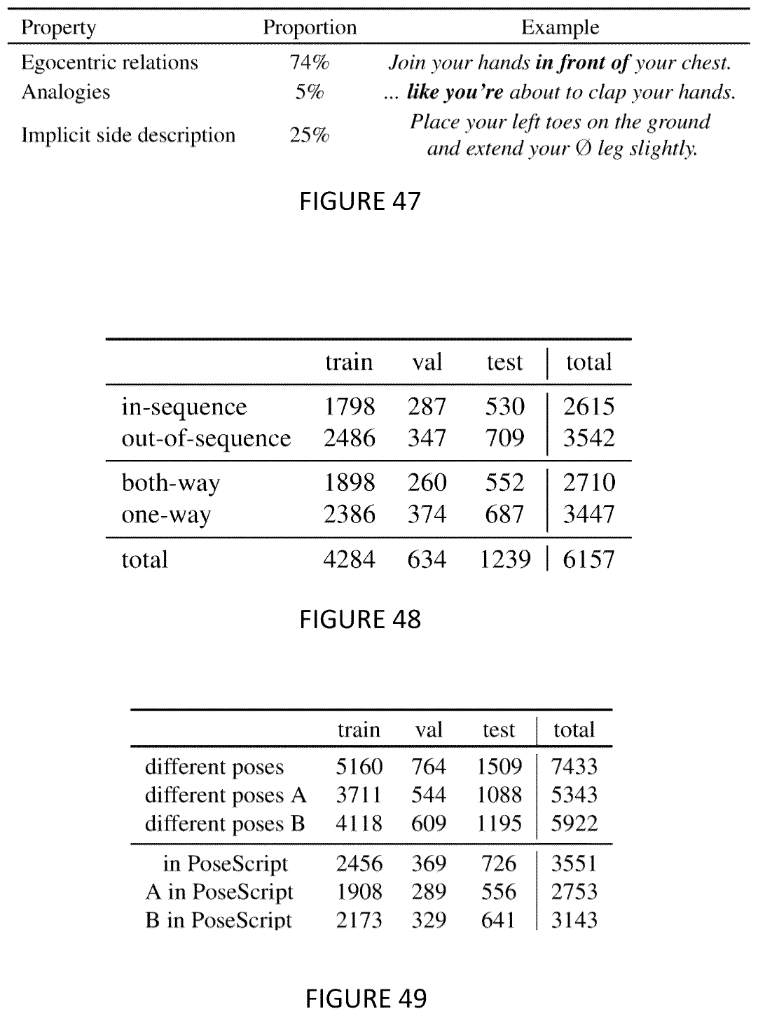

Negation particles were detected in 3.6% of the annotations, which makes textual queries with negations a bit harder. A semantic analysis carried out on 104 annotations taken at random is illustrated by the table in FIG. 47. The textual modifiers provide correctional instructions about 4 different body parts in average, which vary depending on the context (pose A).

A few other annotation behaviors were found to be quite difficult to quantify, in particular “missing” instructions. Sometimes, details are omitted in the text because the context given by pose A is “taken for granted.” For instance, in the example shown in FIG. 35, the “45-degree angle” is to be understood with regard to the “0 degree” plane defined by the back of the body in pose A. Moreover, the annotations do not specify how the position of the arms have changed, supposedly because this change comes naturally once the back is straightened up, from the structure of the kinematic chain.

Detailed statistics about annotated pairs are illustrated by the table in FIG. 48, while statistics about poses A and B from annotated triplets are illustrated by the table in FIG. 49.

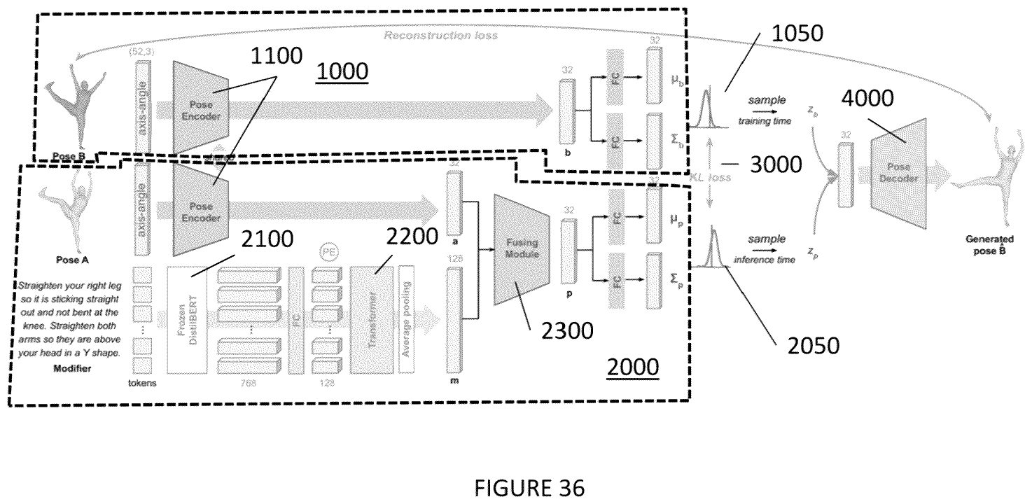

A variational auto-encoder baseline performs text-based three-dimensional human pose editing. Specifically, plausible new poses are generated based on two input elements: an initial pose A providing some context (a starting point for modifications), and a textual modifier which specifies the changes to be made. FIG. 36 gives an overview of the system using the variational auto-encoder.

As illustrated in FIG. 36, the top part of FIG. 36 represents a standard variational auto-encoder 1000, where poses are encoded (1100) into a Gaussian distribution 1050. At training time, a latent variable is sampled and decoded into a pose to learn pose reconstruction.

The bottom left part of FIG. 36 represents a text conditioning pipeline 2000, wherein user generated text is encoded using a frozen DistillBERT 2100 with a small transformer 2200 on top. It is combined with source pose features in fusion module 2300, from which a Gaussian distribution is predicted 2050. A KL loss 3000 ensures the alignment of the distributions from the standard variational auto-encoder and the conditioning. At test time, the latter is sampled to predict the target pose. The pose decoder 4000 converts a sample (coming either from the pose distribution 1050 or the conditional distribution 2050) to a three-dimensional pose.

Poses are characterized by their SMPL-H body joint rotations in axis-angle representation. Their global orientation is first normalized along the y-axis. For in-sequence pairs, the same normalization that was applied to pose A is applied to pose B in order to preserve information about the change of global orientation.

During training, the model encodes both the query pose A and the ground-truth target pose B using a shared pose encoder 1100, yielding respectively features a and b in R^{d}. The tokenized text modifier is fed into a frozen pre-trained transformer 2100, namely DistillBERT, to extract expressive word encodings.

These are further passed to a trainable transformer 2200, and average-pooled to yield a global textual representation m∈Rⁿ. Next, the two input embeddings a and m are provided to a fusing module 2300 which outputs a single vector p E R^{d}. Both b and p then go through specific fully connected layers to produce the parameters of two Gaussian distributions: the posterior N_{b}=N(·|μ(b), Σ(b)) and the prior Nₚ=N(·|μ(p), Σ(p)) conditioned on p from the fusion of a and m. In alternate embodiments, distributions with shapes that approximate the Gaussian distribution such as the t-distribution may be used. Eventually, a sampled latent variable z_{b}˜N_{b} is decoded into a reconstructed pose B′.

The loss consists in the sum of a reconstruction term L_{R}(B, B′) and the Kullback-Leibler (KL) divergence (i.e., similarity measure) between N_{b} and Nₚ. The former enables the generation of plausible poses, while the latter acts as a regularization term to align the two spaces. The combined loss is then:

$${L}_{pose editing} = {L}_{R} ( B , {B}^{′} ) + {L}_{KL} ( {N}_{b} , {N}_{P} ) .$$

A negative log likelihood-based reconstruction loss is applied to the output joint rotations in the continuous six-dimensional representation, and both the joint and vertices positions are inferred from the output by the SMPL-H model.

In the inference phase, the input pose A and text are processed as in the training phase. However, zₚ˜Nₚ is sampled to obtain the predicted pose B′.

The Evidence Lower Bound (ELBO) for the size-normalized rotations, joints and vertices, as well as the Fréchet inception distance (FID) which compares the distribution of the generated poses with the one of the expected poses, based on their semantic PoseScript features, are reported.

A VPoser architecture is used for the pose auto-encoder, resulting in features of dimension d=32. The variance of the decoder 4000 is considered a learned constant. A pre-trained frozen DistilBERT is used for word encoding and set n to 128, as the model is found to benefit from a larger, more expressive, textual encoding.

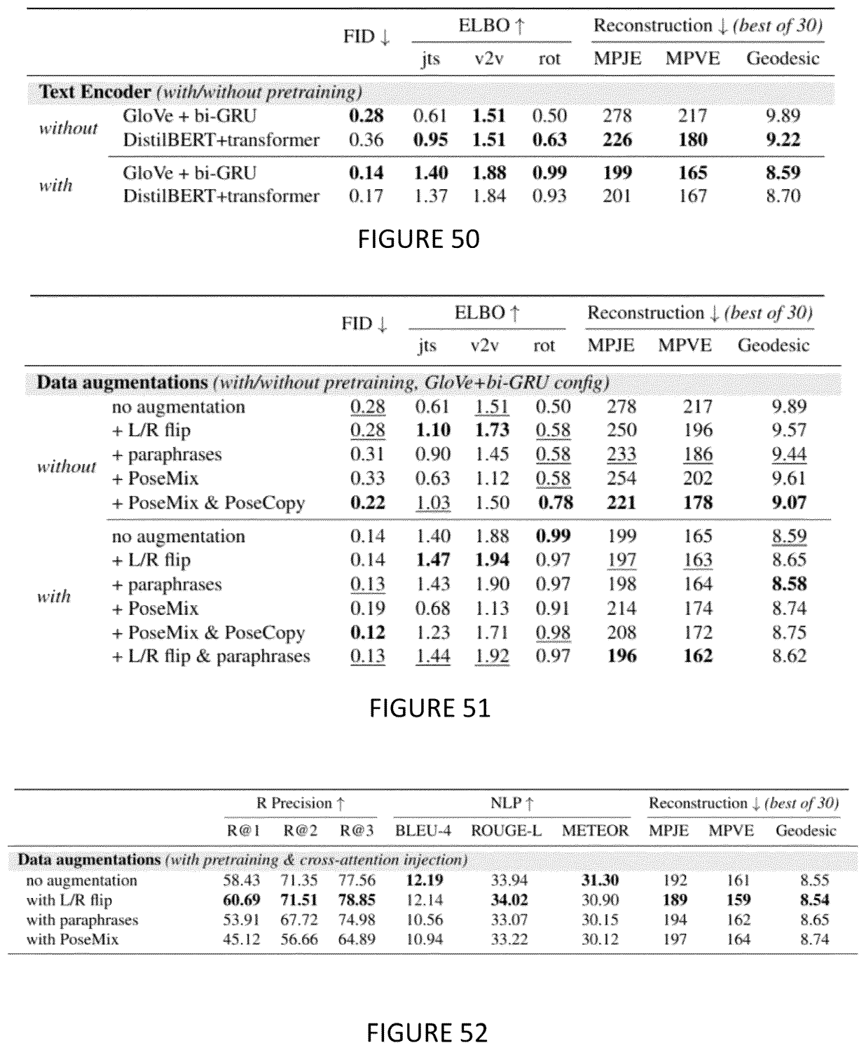

A bi-GRU text encoder mounted on top of pretrained GloVe word embeddings can be used to produce results on part with the transformer-like pipeline when benefiting from pretraining on the automatic modifiers. Without pretraining, the transformer was found to yield a better ELBO, supposedly because it uses already strong general-pretrained weights. This is illustrated by the table in FIG. 50.

For fusion, TIRG, a well-spread module for compositional learning, is used. It consists in a gating mechanism composed of two 2-layer Multi-Layer Perceptrons (MLP) f and g balanced by learned scalars wf and w_{g} such that

$$p = {w}_{f} f ( [ a , m ] ) ⊙ a + {w}_{g} g ( [ a , m ] ) .$$

It is designed to ‘preserve’ the main modality feature a, while applying the modification as a residual connection.

Several kinds of data augmentations and training data were used. The results are shown in the table illustrated in FIG. 51. First, left/right flipping was done by swapping the rotations of the left and right body joints (e.g. the left hand becomes the right hand) and changing the text accordingly.

Next, InstructGPT was used to obtain 2 paraphrases per annotation. This form of data augmentation was found helpful in regards of all metrics, especially when the model did not benefit from pretraining on automatic modifiers.

Moreover, PoseMix was defined, which gathers both the PoseScript and the PoseFix datasets. When training with PoseScript data, which consist in pairs of poses and textual descriptions, pose A is set to 0.

Although the formulation in the descriptions (“The person is . . . with their left hand . . . ”) and the modifiers (“Move your left hand . . . ”) differ, this yields a great improvement over all metrics in the non-pretrained case, when combined with PoseCopy, described below. Using PoseMix+PoseCopy has a greater impact than using the paraphrases in the non-pretrained case, although the amount of added data is twice smaller and the increase in vocabulary size is analogous. This can be explained by the fact that, when training on PoseMix, the model sees close to 150% more various poses than when training on PoseFix alone. In the pretrained case, the effect of PoseMix+PoseCopy is mitigated, probably because the model already learned from diverse poses in the pretraining phase.

The model was also provided with the same pose in the role of pose A and pose B, along with an empty modifier. A nonexistent textual query will force the model to attend pose A, a bit like using PoseScript with an empty pose A forced the model to fully leverage the textual cue. This process is PoseCopy. It is noted that, when training the model with PoseCopy, the fusing branch is now able to work as a pseudo auto-encoder and output a copy of the input pose when no modification instruction is provided.

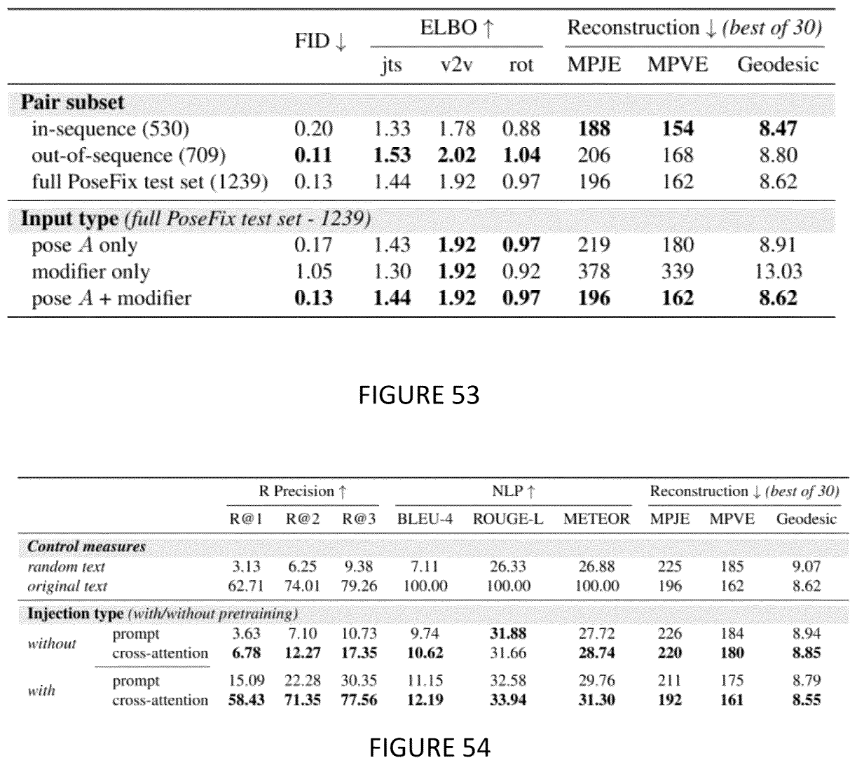

As illustrated in the table of FIG. 53, results for pose editing model on several subsets of pairs and with different input types are shown. As shown, metrics on the out-of-sequence pair set are better compared to the in-sequence set, suggesting pairs in the latter are harder. This is probably because pose A and pose B are more similar (the poses belong to the same sequence, with a maximum delay of 0.5 s). The mean per joint distance between A and B was indeed measured in each set and was found to be 311 mm in IS vs. 350 mm in OOS.

Next, the results are compared when querying with the pose only or the modifier only. The former achieves already high performance, showing that the initial pose A alone provides a good approximation of the expected pose B-indeed, the pair selection process constrained pose A and pose B to be quite similar. The latter yields poor FID and reconstruction metrics: the textual cue is only a modifier, and the same instructions could apply to a large variety of poses. Looking around pose A remains a better strategy than sticking to the sole modifier in order to generate the expected pose.

Eventually, both parts of the query are complementary: pose A serves as a strong contextual cue, and the modifier guides the search starting from it (the pose being provided through the gating mechanism in TIRG). Both are crucial to reach pose B.

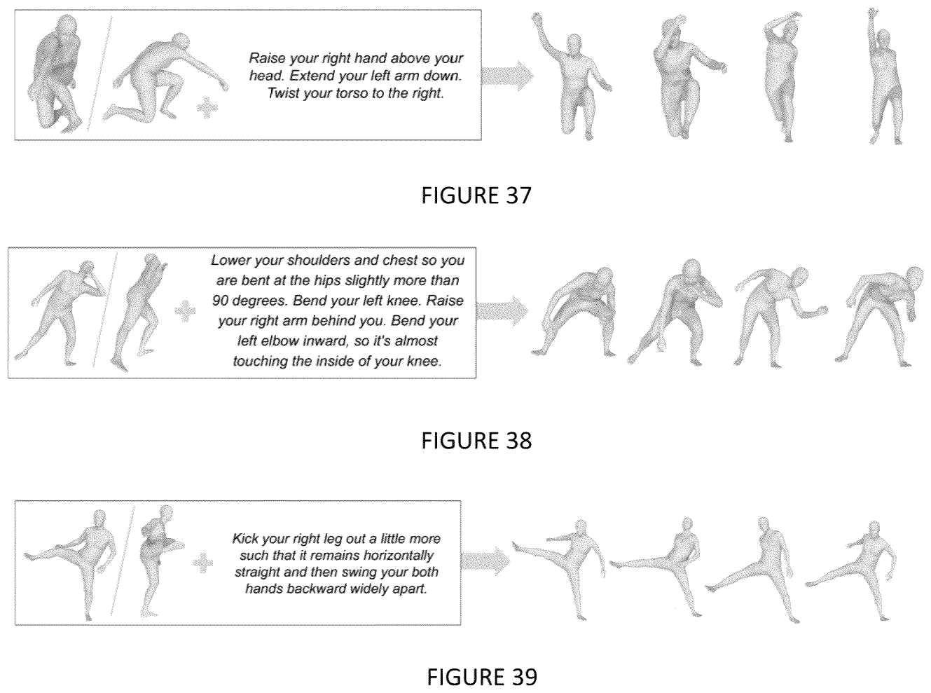

Qualitative results for text-based three-dimensional human pose editing are illustrated in FIGS. 37-40. As illustrated in FIG. 37-40, qualitative results on the text-based pose editing tasks from a test set of PoseFix: the poses on the right are some generated poses for the dual queries shown in the left blocks, where pose A is rendered in the front and side views.

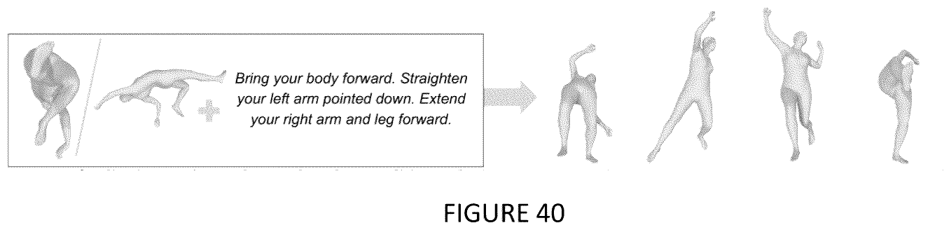

The model has a relatively good semantic comprehension of the different body parts and of the actions to modify their positions. Some egocentric relations (“Raise your hand above your head”—FIG. 37) are better understood than others, in particular contact requirements (“Bend your elbow so it's almost touching the inside of your knee”—FIG. 38). Sitting and lying-down poses are the most challenging (see failure case in FIG. 40).

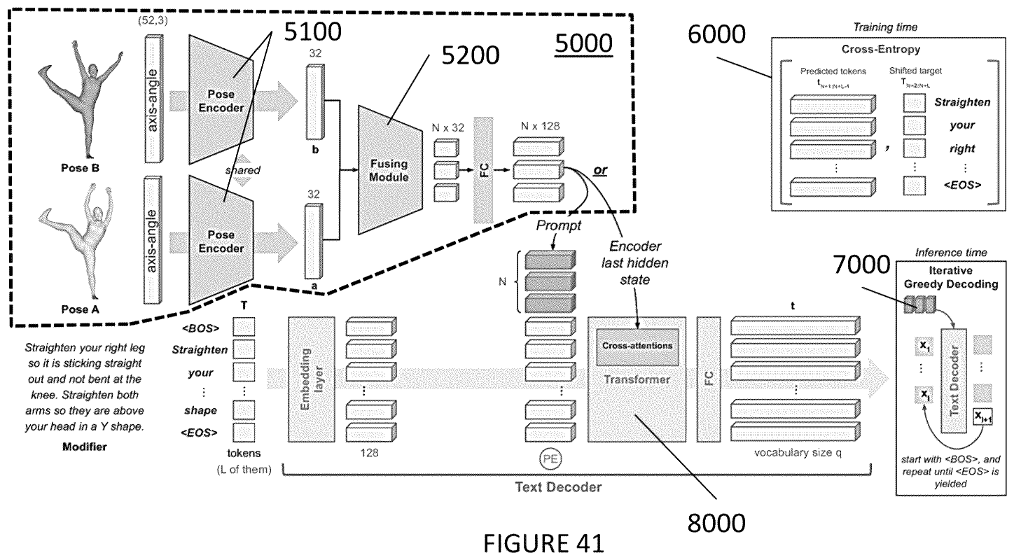

A baseline for correctional text generation is used to produce feedback in natural language explaining how the source pose A should be modified to obtain the target pose B. An auto-regressive model, conditioned on the pose pair, is used, which iteratively predicts the next word given the previously generated ones, as illustrated in FIG. 41.

FIG. 41 illustrates an overview of a baseline for correctional text generation. The bottom part of FIG. 41 represents a standard auto-regressive transformer model, wherein the next word is predicted from the previously generated tokens. The decoder outputs a distribution of probabilities over the vocabulary for each token. The top part 5000 of FIG. 41 represents the conditioning on the pose pair: the two pose embeddings are fused together (5200) into a set of “pose tokens,” further used for conditioning via prompting (i.e., adding extra tokens before the text tokens) or via cross-attentions in the transformer. At inference, the modifier is generated iteratively using the greedy approach 7000.

For training 6000, Let T_{1:L} be the L tokens of the text modifier. An auto-regressive generative module (model) 8000 seeks to predict the next token I+1 from the first I tokens T_{1:I}. Let p(·|T_{1:I}) be the predicted probability distribution over the vocabulary. The auto-regressive generative module (model) 8000 is trained, via a cross-entropy loss, to maximize the probability of generating the ground-truth token T_{I+1} given previous ones: p(T_{I+1}|T_{1:I}).

To predict the p(·|T_{1:I}), the tokens T_{1:I} are first embedded, and then added to positional encodings. The result is fed to a series of transformer blocks and projected into a space whose dimension is the vocabulary size q. Let t∈R^{q} denote the outcome. The probability distribution over the vocabulary for the next token p(·|T_{1:I}) could be obtained from Softmax (t).

The transformer-based auto-regressive module (model) 8000 can be trained efficiently using causal attention masks which, for each token I, prevent the network from attending all future tokens I′>I, in a single pass.

Pose A and pose B are encoded using a shared encoder 5100, and combined in the fusing module 5200, which outputs a set of N ‘pose’ tokens. To condition the text generation on pose information, two alternatives are used: those pose tokens can either be used for prompting; i.e., added as extra tokens at the beginning of the modifier; or serve in cross-attention mechanisms within the auto-regressive generative module (model) 8000.

Standard natural language metrics: BLEU-4, Rouge-L, and METEOR are used, which measure different kinds of n-grams overlaps between the reference text and the generated one. Yet, these metrics do not reliably reflect the model quality for this task. Indeed, there is only one reference text and, given the initial pose, very different instructions can lead to the same result (e.g. “lower your arm at your side” and “move your right hand next to your hip”); it is not just a matter of formulation.

Thus, the top-k R-precision metrics proposed in TM2T are also reported, based on an auxiliary model: contrastive learning is used to train a joint embedding space for the modifiers and the concatenation of poses A and B, then the rank of the correct pose pair for each generated text is searched within a set of 32 pose pairs. Besides, reconstruction metrics on the pose generated thanks to the pose editing model presented before, using the generated text, are also reported. These added metrics assess the semantic correctness of the generated texts.

The quantitative results are presented in tables illustrated in FIGS. 52 and 54 A fusing module, TIRG with the gating applied on pair leading pose (pose B) is used; thus, using N=1.

The pose information in the text decoder is injected into the decoder using prompting and cross-attention, wherein cross-attention yielded the best results. Similarly, to the pose editing task, the paraphrases helped, as well as, the left/right flip.

Pretraining on automatic modifiers significantly boosts performance. Regarding data augmentations, the left/right flip yields additional gains with results close to those obtained with the ground-truth texts, both for R-precision and reconstruction. Even if the generated text does not have the same wording as the original text (low NLP metrics), combined with pose A, it achieves to produce a satisfactory pose \hat{ }B, meaning that it carries the right correctional information. However, it should be noted that the added metrics rely on imperfect models, which have their own limitations. Finally, a decrease in performance is observed with the paraphrases or the PoseMix settings: it can be hypothesized that these settings are harder than the regular one for this task, due to new words and formulations.

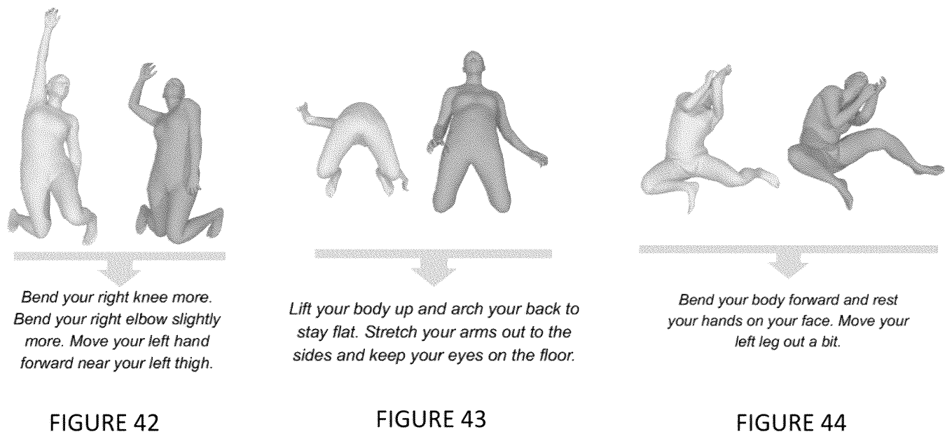

FIGS. 42-46 show some generation results wherein the left pose is Pose A and the right pose is Pose B.

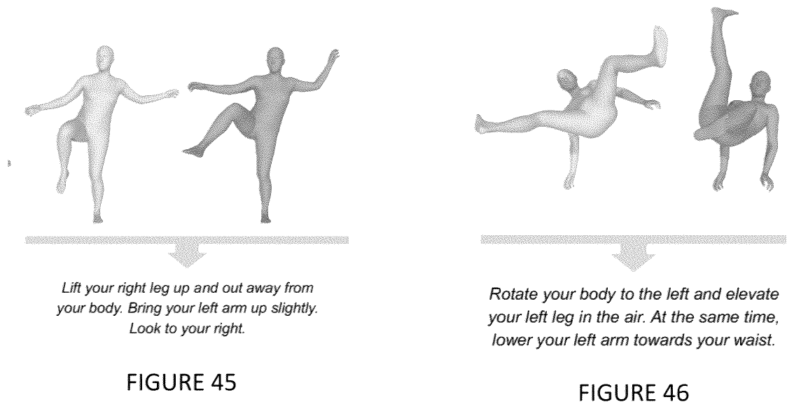

To some extent, the model is able to produce satisfying feedback, with indications to achieve different body parts positions (FIGS. 43 and 45) and egocentric relations (FIGS. 42 and 44). However, it tends to mix up pose A and B, or left/right information (FIG. 46). It also sometimes describes only a subset of the differences.

The above-described processes and models enable the correcting of three-dimensional human poses using natural language instructions. Going beyond existing methods that utilize language to model global motion or entire body poses, the above-described processes and models capture the subtle differences between pairs of body poses, which requires a new level of semantic understanding. For this purpose, the above-described processes and models use PoseFix, a novel dataset with paired poses and their corresponding correctional descriptions. The above-described processes and models also utilized two baselines which address the deriving tasks of text-based pose editing and correctional text generation.

A system for text-based pose editing to generate a new pose from an initial pose and user-generated text, comprising: a user input device for inputting the initial pose and the user-generated text; a pose encoder, operatively connected to the user input device, configured to receive the initial pose; a text conditioning pipeline, operatively connected to the user input device, configured to receive the user-generated text; a fusing module, operatively connected to the pose encoder and the text conditioning pipeline, configured to produce parameters for a prior distribution Nₚ; a pose decoder, operatively connected to the fusing module, configured to sample the distribution Nₚ and generate, therefrom, the new pose; and an output device, operatively connected to the pose decoder, to communicate the generated new pose to a user; the pose encoder and the text conditioning pipeline being trained using a dataset, the dataset including triplets having a source pose, a target pose, and text modifier; the pose encoder and the text conditioning pipeline being trained by (a) encoding, using the pose encoder, a received source pose into features a′ and a received target pose into features b′, (b) converting, using the text conditioning pipeline, the text modifier to a global text representation m′, (c) fusing, using the fusing module, the training global text representation m′ and training features a′, (d) producing parameters, using the fused training global text representation m′ and training features a′, for the prior distribution Nₚ, (e) producing parameters, using the features b′, for a posterior distribution N_{b}, (f) sampling the posterior distribution N_{b} to create a training pose B′, and (g) using a reconstruction term between the training pose B′ and the received target pose and a similarity measure between the prior distribution Nₚ and the posterior distribution N_{b} to train the pose encoder and the text conditioning pipeline.

The prior distribution Nₚ and the posterior distribution N_{b} may be a Gaussian distribution, the pose encoder may be a variational auto-encoder, the similarity measure may be computed using Kullback-Leibler divergence, and the dataset may be a PoseFix dataset.

The system may further comprise fully connected layers, operatively connected to the fusing module, configured to produce parameters for the posterior Gaussian distribution Nₚ.

The text conditioning pipeline may include a frozen pretrained transformer configured to receive the user-generated text; and a trainable transformer and average pooling unit, operatively connected to the frozen pretrained transformer, configured to yield the global text representation m′; and wherein the frozen pretrained transformer is a frozen DistillBERT transformer.

The Kullback-Leibler divergence may ensure the alignment of Nₚ and N_{b}.

A combined loss, L_{pose editing}=L_{R}(b, B′)+L_{KL}(N_{b}, Nₚ), may be generated and used to train the variational auto-encoder and the text conditioning pipeline.

The user-generated text may be natural language text.

The user-generated text may be audio based.

A computer-implemented method for training a pose generation model for text-based pose editing to generate a new pose from an initial pose and user-generated text, comprises (a) electronically accessing from memory using one or more processors: (i) a pose encoder adapted to generate a pose from the user-generated text, (ii) a text conditioning pipeline, (iii) a dataset that includes triplets having a corresponding source pose, target pose, and text modifier, and (iv) a fusing module; and (b) electronically training the pose generation model with corresponding triplets from the dataset using one or more processors by (b1) using the pose encoder for encoding the source pose and the target pose for corresponding triplets into training features a′ and training features b′, respectively, (b2) using the text conditioning pipeline for tokenizing the text modifier of corresponding triplets received from the dataset to create training text tokens, (b3) using the text conditioning pipeline, for corresponding triplets, for extracting word encodings from the training text tokens and converting the extracted word encoding to a training global text representation m′, (b4) using the fusing module for fusing, for corresponding triplets, the training global text representation m′ and the training features a′ to output a training vector p′ for corresponding triplets, (b5) producing, for corresponding triplets, parameters for a prior distribution Nₚ, conditioned on p′ from fusion of a′ and m′, and parameters for a posterior distribution N_{b}, (b6) sampling, for corresponding triplets, a latent variable z_{b} from the posterior distribution N_{b} to create a training pose B′, and (b7) determining, for corresponding triplets, a reconstruction term between the training pose B′ and the received target pose, and a similarity measure between the prior distribution Nₚ and the posterior distribution N_{b}.

The prior distribution Nₚ and the posterior distribution N_{b} may be a Gaussian distribution, the pose encoder may be a variational auto-encoder, and the similarity measure may be computed using Kullback-Leibler divergence.

The prior Gaussian distribution Nₚ may be given by: Nₚ=N(·|μ(p), Σ(p)) and the posterior Gaussian distribution N_{b} is given by: N_{b}=N(·|μ(b), Σ(b)) b′.

The Kullback-Leibler divergence may ensure the alignment of Nₚ and N_{b}.

A combined loss, L_{pose editing}=L_{R}(b, B′)+LKL (N_{b}, Nₚ), may be generated and used to train the system for text-based pose editing.

A system for generating correctional pose text to communicate to a use how the user should modify a current pose to obtain a desired pose, comprises a user input device for inputting the current pose; a pose encoder configured to receive the inputted current pose and the desired pose; the pose encoder encoding the inputted current pose to generate a current pose embedding; the pose encoder encoding the desired pose to generate a desired pose embedding; a fusing module, operatively connected to the pose encoder, to fuse the current pose embedding with the desired pose embedding to generate a set of pose tokens; a transformer module including a transformer, operatively connected to the fusing module, configured to generate the correctional text, conditioned by the generated set of pose tokens; and an output device to communicate the generated correctional text to the user; the transformer module being trained, using a dataset, the dataset including triplets having a source pose, a target pose, and text modifier; the transformer module being trained by (a) encoding, using the pose encoder, the source pose into features a′, (b) encoding, using the pose encoder, the target pose into features b′, (c) fusing, using the fusing module, the features a′ and features b′ to output a set of training pose tokens, (d) tokenizing the text modifier to create training text tokens, (e) generating, using the transformer module, correctional text based upon the training text tokens conditioned by the set of training pose tokens, and (f) using a loss, the loss maximizing a probability of generating a ground-truth token given previous tokens, to train the transformer module.

The loss may be a cross-entropy loss, the pose encoder may be a variational auto-encoder, and the dataset may be a PoseFix dataset.

The loss may be a cross-entropy loss, the transformer module may be an auto-regressive transformer module, and the set of training pose tokens may prompt the auto-regressive transformer module.

The loss may be a cross-entropy loss, the transformer module may be an auto-regressive transformer module, and the set of training pose tokens may be used in cross-attention mechanisms in the auto-regressive transformer.

A computer-implemented method for training a pose generation model for generating correctional pose text to communicate to a user how the user should modify a current pose to obtain a desired pose, comprises (a) electronically accessing from memory using one or more processors: (i) a pose encoder, (ii) a transformer module including a transformer adapted to generate the correctional pose text, (iii) a dataset that includes triplets having a corresponding source pose, target pose, and text modifier, and (iv) a fusing module; and (b) electronically training the pose generation model with corresponding triplets from the dataset using one or more processors by (b1) using the pose encoder for encoding the source pose and the target pose for corresponding triplets into features a′ and features b′, respectively, (b2) using the fusing module for fusing the features a′ and features b′ to output a set of training pose tokens, (b3) tokenizing the text modifier for corresponding triplets to create training text tokens, (b4) using the transformer module for generating correctional text for corresponding triplets based upon the training text tokens conditioned by the set of training pose tokens, and (b5) using a loss to maximize for corresponding triplets a probability of generating a ground-truth token given previous tokens.

The loss is a cross-entropy loss, the transformer module may be an auto-regressive transformer module, and the set of training pose tokens may prompt the auto-regressive transformer module.

The loss may be a cross-entropy loss, the transformer module may be an auto-regressive transformer module, and the set of training pose tokens may be used in cross-attention mechanisms in the auto-regressive transformer.

A computer-implemented method for using a pose generation model for text-based pose editing to generate a new pose from an initial pose and user-generated text, comprises (a) electronically accessing from memory using one or more processors: (i) a pose encoder adapted to generate a pose from the user-generated text, (ii) a text conditioning pipeline, (iii) a fusing module, and (iv) a pose decoder; and (b) electronically generating the new pose from the initial pose and the user-generated text with the pose generation model using one or more processors by (b1) using the pose encoder for encoding the initial pose into features a, (b2) using the text conditioning pipeline for tokenizing the user-generated text to create text tokens, (b3) using the text conditioning pipeline for extracting word encodings from the text tokens and converting the extracted word encoding to a global text representation m, (b4) using the fusing module for fusing the global text representation m and the features a to output a vector p, (b5) producing parameters for a distribution N, conditioned on the vector p from fusion of the features a and the global text representation m, and (b6) using the pose decoder to generate the new pose by sampling a latent variable zₚ from the distribution N.

A computer-implemented method for using a pose generation model for generating correctional pose text to communicate to a user how the user should modify a current pose to obtain a desired pose, comprises (a) electronically accessing from memory using one or more processors: (i) a pose encoder, (ii) a transformer module including a transformer adapted to generate the correctional pose text, and (iii) a fusing module; and (b) electronically generating the correctional pose text with the pose generation model using one or more processors by (b1) using the pose encoder for encoding the current pose and the desired pose into features a and features b, respectively, (b2) using the fusing module for fusing the features a and the features b to output a set of pose tokens, and (b3) using the for generating the correctional pose text based upon the set of pose tokens.

A system for text-based pose editing to generate a new pose from an initial pose and user-generated text, comprises an user input device for inputting the initial pose and the user-generated text; a variational auto-encoder, operatively connected to the user input device, configured to receive the initial pose; a text conditioning pipeline, operatively connected to the user input device, configured to receive the user-generated text; a fusing module, operatively connected to the variational auto-encoder and the text conditioning pipeline, configured to produce parameters for a prior Gaussian distribution Nₚ; a pose decoder, operatively connected to the fusing module, configured to sample the Gaussian distribution Nₚ and generate, therefrom, the new pose; and an output device, operatively connected to the pose decoder, to communicate the generated new pose to a user; the variational auto-encoder and the text conditioning pipeline being trained using a PoseFix dataset, the PoseFix dataset including triplets having a source pose, a target pose, and text modifier; the variational auto-encoder and the text conditioning pipeline being trained by (a) encoding, using the variational auto-encoder, a received source pose into features a′ and a received target pose into features b′, (b) converting, using the text conditioning pipeline, the text modifier to a global text representation m′, (c) fusing, using the fusing module, the training global text representation m′ and training features a′, (d) producing parameters, using the fused training global text representation m′ and training features a′, for the prior Gaussian distribution Nₚ, (e) producing parameters, using the features b′, for a posterior Gaussian distribution N_{b}, (f) sampling the posterior Gaussian distribution N_{b} to create a training pose B′, and (g) using a reconstruction term between the training pose B′ and the received target pose and a Kullback-Leibler divergence between the prior Gaussian distribution Nₚ and the posterior Gaussian distribution N_{b} to train the variational auto-encoder and the text conditioning pipeline.

The text conditioning pipeline may include a frozen pretrained transformer configured to receive the user-generated text; and a trainable transformer and average pooling unit, operatively connected to the frozen pretrained transformer, configured to yield the global text representation m′.

The system may further comprise fully connected layers, operatively connected to the fusing module, configured to produce parameters for the posterior Gaussian distribution Nₚ.

The frozen pretrained transformer may be a frozen DistillBERT transformer.

The Kullback-Leibler divergence ensures the alignment of Nₚ and N_{b}.

A combined loss, L_{pose editing}=L_{R}(b, B′)+L_{KL}(N_{b}, Nₚ), may be generated and used to train the variational auto-encoder and the text conditioning pipeline.

The user-generated text may be natural language text.

The user-generated text may be audio based.

A computer-implemented method for training a pose generation model for text-based pose editing to generate a new pose from an initial pose and user-generated text, comprises electronically accessing from memory using one or more processors: (i) a variational auto-encoder adapted to generate a pose from the user-generated text, (ii) a text conditioning pipeline, (iii) a dataset that includes triplets having a corresponding source pose, target pose, and text modifier, and (iv) a fusing module; and electronically training the pose generation model with corresponding triplets from the dataset using one or more processors by (a) using the variational auto-encoder for encoding the source pose and the target pose for corresponding triplets into training features a′ and training features b′, respectively; (b) using the text conditioning pipeline for tokenizing the text modifier of corresponding triplets received from the dataset to create training text tokens; (c) using the text conditioning pipeline, for corresponding triplets, for extracting word encodings from the training text tokens and converting the extracted word encoding to a training global text representation m′; (d) using the fusing module for fusing, for corresponding triplets, the training global text representation m′ and the training features a′ to output a training vector p′ for corresponding triplets; (e) producing, for corresponding triplets, parameters for a prior Gaussian distribution Nₚ, conditioned on p′ from fusion of a′ and m′, and parameters for a posterior Gaussian distribution N_{b}; (f) sampling, for corresponding triplets, a latent variable z_{b} from the posterior Gaussian distribution N_{b} to create a training pose B′; and (g) determining, for corresponding triplets, a reconstruction term between the training pose B′ and the received target pose, and a Kullback-Leibler divergence between the prior Gaussian distribution Nₚ and the posterior Gaussian distribution N_{b}.

The prior Gaussian distribution Nₚ may be given by: Nₚ=N(·|μ(p), Σ(p)).

The posterior Gaussian distribution N_{b} may be given by: N_{b}=N(·|μ(b), Σ(b)) b′.

The Kullback-Leibler divergence ensures the alignment of Nₚ and N_{b}.

A combined loss, L_{pose editing}=L_{R}(b, B′)+L_{KL}(N_{b}, Nₚ), may be generated and used to train the system for text-based pose editing.

A system for generating correctional pose text to communicate to a use how the user should modify a current pose to obtain a desired pose, comprises an user input device for inputting the current pose; a pose encoder configured to receive the inputted current pose and the desired pose; the pose encoder encoding the inputted current pose to generate a current pose embedding; the pose encoder encoding the desired pose to generate a desired pose embedding; a fusing module, operatively connected to the pose encoder, to fuse the current pose embedding with the desired pose embedding to generate a set of pose tokens; an auto-regressive transformer, operatively connected to the fusing module, configured to generate the correctional text, conditioned by the generated set of pose tokens; and an output device to communicate the generated correctional text to the user; the auto-regressive transformer module being trained, using a PoseFix dataset, the PoseFix dataset including triplets having a source pose, a target pose, and text modifier; the auto-regressive transformer module being trained by (a) encoding, using the pose encoder, the source pose into features a′, (b) encoding, using the pose encoder, the target pose into features b′, (c) fusing, using the fusing module, the features a′ and features b′ to output a set of training pose tokens, (d) tokenizing the text modifier to create training text tokens, (e) generating, using the auto-regressive transformer module, correctional text based upon the training text tokens conditioned by the set of training pose tokens, and (f) using cross-entropy loss, the cross-entropy loss maximizing a probability of generating a ground-truth token given previous tokens, to train the auto-regressive transformer module.

The pose encoder may be a variational auto-encoder.

The auto-regressive transformer module may maximize a negative log likelihood.

The set of training pose tokens may prompt the auto-regressive transformer module.

The set of training pose tokens may be used in cross-attention mechanisms in the auto-regressive transformer.

A computer-implemented method for training a pose generation model for generating correctional pose text to communicate to a user how the user should modify a current pose to obtain a desired pose, comprises electronically accessing from memory using one or more processors: (i) a pose encoder, (ii) an auto-regressive transformer module including an auto-regressive transformer adapted to generate the correctional pose text, (iii) a dataset that includes triplets having a corresponding source pose, target pose, and text modifier, and (iv) a fusing module; and electronically training the pose generation model with corresponding triplets from the dataset using one or more processors by (a) using the pose encoder for encoding the source pose and the target pose for corresponding triplets into features a′ and features b′, respectively; (b) using the fusing module for fusing the features a′ and features b′ to output a set of training pose tokens; (c) tokenizing the text modifier for corresponding triplets to create training text tokens; (d) using the auto-regressive transformer module for generating correctional text for corresponding triplets based upon the training text tokens conditioned by the set of training pose tokens; and (e) using a cross-entropy loss to maximize for corresponding triplets a probability of generating a ground-truth token given previous tokens.

The set of training pose tokens may prompt the auto-regressive transformer module.

The set of training pose tokens may be used in cross-attention mechanisms in the auto-regressive transformer.

It will be appreciated that variations of the above-disclosed embodiments and other features and functions, and/or alternatives thereof, may be desirably combined into many other different systems and/or applications. Also, various presently unforeseen and/or unanticipated alternatives, modifications, variations, and/or improvements therein may be subsequently made by those skilled in the art which are also intended to be encompassed by the description above.

What is claimed is:

1. A system for text-based pose editing to generate a new pose from an initial pose and user-generated text, comprising:
a user input device for inputting the initial pose and the user-generated text;
a pose encoder, operatively connected to said user input device, configured to receive the initial pose;
a text conditioning pipeline, operatively connected to said user input device, configured to receive the user-generated text;
a fusing module, operatively connected to said pose encoder and said text conditioning pipeline, configured to produce parameters for a prior distribution Nₚ;
a pose decoder, operatively connected to said fusing module, configured to sample the distribution Nₚ and generate, therefrom, the new pose; and
an output device, operatively connected to said pose decoder, to communicate the generated new pose to a user;
said pose encoder and said text conditioning pipeline being trained using a dataset, the dataset including triplets having a source pose, a target pose, and text modifier;
said pose encoder and said text conditioning pipeline being trained by
(a) encoding, using said pose encoder, a received source pose into features a′ and a received target pose into features b′,
(b) converting, using said text conditioning pipeline, the text modifier to a global text representation m′,
(c) fusing, using the fusing module, the training global text representation m′ and training features a′,
(d) producing parameters, using the fused training global text representation m′ and training features a′, for the prior distribution Nₚ,
(e) producing parameters, using the features b′, for a posterior distribution N_{b},
(f) sampling the posterior distribution N_{b} to create a training pose B′, and
(g) using a reconstruction term between the training pose B′ and the received target pose and a similarity measure between the prior distribution Nₚ and the posterior distribution N_{b} to train said pose encoder and said text conditioning pipeline.

2. The system as claimed in claim 1, wherein the prior distribution Nₚ and the posterior distribution N_{b} are a Gaussian distribution, the pose encoder is a variational auto-encoder, the similarity measure is computed using Kullback-Leibler divergence, and the dataset is a PoseFix dataset.

3. The system as claimed in claim 2, further comprising:
fully connected layers, operatively connected to said fusing module, configured to produce parameters for the posterior Gaussian distribution Nₚ.

4. The system as claimed in claim 2, wherein said text conditioning pipeline includes:
a frozen pretrained transformer configured to receive the user-generated text; and
a trainable transformer and average pooling unit, operatively connected to said frozen pretrained transformer, configured to yield the global text representation m′; and
wherein said frozen pretrained transformer is a frozen DistillBERT transformer.

5. The system as claimed in claim 2, wherein said Kullback-Leibler divergence ensures the alignment of Nₚ and Nₚ.

6. The system as claimed in claim 2, wherein a combined loss, L_{pose editing}=L_{R}(b, B′)+L_{KL}(N_{b}, Nₚ), is generated and used to train said variational auto-encoder and said text conditioning pipeline.

7. The system as claimed in claim 2, wherein the user-generated text is natural language text.

8. The system as claimed in claim 2, wherein the user-generated text is audio based.

9. A computer-implemented method for training a pose generation model for text-based pose editing to generate a new pose from an initial pose and user-generated text, comprising:
(a) electronically accessing from memory using one or more processors: (i) a pose encoder adapted to generate a pose from the user-generated text, (ii) a text conditioning pipeline, (iii) a dataset that includes triplets having a corresponding source pose, target pose, and text modifier, and (iv) a fusing module; and
(b) electronically training the pose generation model with corresponding triplets from the dataset using one or more processors by
(b1) using the pose encoder for encoding the source pose and the target pose for corresponding triplets into training features a′ and training features b′, respectively,
(b2) using the text conditioning pipeline for tokenizing the text modifier of corresponding triplets received from the dataset to create training text tokens,
(b3) using the text conditioning pipeline, for corresponding triplets, for extracting word encodings from the training text tokens and converting the extracted word encoding to a training global text representation m′,
(b4) using the fusing module for fusing, for corresponding triplets, the training global text representation m′ and the training features a′ to output a training vector p′ for corresponding triplets,
(b5) producing, for corresponding triplets, parameters for a prior distribution Nₚ, conditioned on p′ from fusion of a′ and m′, and parameters for a posterior distribution N_{b},
(b6) sampling, for corresponding triplets, a latent variable z_{b} from the posterior distribution N_{b} to create a training pose B′, and
(b7) determining, for corresponding triplets, a reconstruction term between the training pose B′ and the received target pose, and a similarity measure between the prior distribution Nₚ and the posterior distribution N_{b}.

10. The method as claimed in claim 9, wherein the prior distribution Nₚ and the posterior distribution N_{b} are a Gaussian distribution, the pose encoder is a variational auto-encoder, and the similarity measure is computed using Kullback-Leibler divergence.

11. The method as claimed in claim 10, wherein the prior Gaussian distribution Nₚ is given by: Nₚ=N(·|μ(p), Σ(p)) and the posterior Gaussian distribution N_{b} is given by: N_{b}=N(·|μ(b), Σ(b)) b′.

12. The method as claimed in claim 10, wherein said Kullback-Leibler divergence ensures the alignment of Nₚ and N_{b}.

13. The method as claimed in claim 10, wherein a combined loss, L_{pose editing}=L_{R}(b, B′)+L_{KL}(N_{b}, Nₚ), is generated and used to train the system for text-based pose editing.

14. A system for generating correctional pose text to communicate to a use how the user should modify a current pose to obtain a desired pose, comprising:
a user input device for inputting the current pose;
a pose encoder configured to receive the inputted current pose and the desired pose;
said pose encoder encoding the inputted current pose to generate a current pose embedding;
said pose encoder encoding the desired pose to generate a desired pose embedding;
a fusing module, operatively connected to said pose encoder, to fuse the current pose embedding with the desired pose embedding to generate a set of pose tokens;
a transformer module including a transformer, operatively connected to said fusing module, configured to generate the correctional text, conditioned by the generated set of pose tokens; and
an output device to communicate the generated correctional text to the user;
said transformer module being trained, using a dataset, the dataset including triplets having a source pose, a target pose, and text modifier;
said transformer module being trained by
(a) encoding, using said pose encoder, the source pose into features a′,
(b) encoding, using said pose encoder, the target pose into features b′,
(c) fusing, using said fusing module, the features a′ and features b′ to output a set of training pose tokens,
(d) tokenizing the text modifier to create training text tokens,
(e) generating, using said transformer module, correctional text based upon the training text tokens conditioned by the set of training pose tokens, and
(f) using a loss, the loss maximizing a probability of generating a ground-truth token given previous tokens, to train said transformer module.

15. The system as claimed in claim 14, wherein the loss is a cross-entropy loss, said pose encoder is a variational auto-encoder and the dataset is a PoseFix dataset.

16. The system as claimed in claim 14, wherein the loss is a cross-entropy loss, the transformer module is an auto-regressive transformer module and the set of training pose tokens prompt said auto-regressive transformer module.

17. The system as claimed in claim 14, wherein the loss is a cross-entropy loss, the transformer module is an auto-regressive transformer module, and the set of training pose tokens are used in cross-attention mechanisms in said auto-regressive transformer.

18. A computer-implemented method for training a pose generation model for generating correctional pose text to communicate to a user how the user should modify a current pose to obtain a desired pose, comprising:
(a) electronically accessing from memory using one or more processors: (i) a pose encoder, (ii) a transformer module including a transformer adapted to generate the correctional pose text, (iii) a dataset that includes triplets having a corresponding source pose, target pose, and text modifier, and (iv) a fusing module; and
(b) electronically training the pose generation model with corresponding triplets from the dataset using one or more processors by
(b1) using the pose encoder for encoding the source pose and the target pose for corresponding triplets into features a′ and features b′, respectively,
(b2) using the fusing module for fusing the features a′ and features b′ to output a set of training pose tokens,
(b3) tokenizing the text modifier for corresponding triplets to create training text tokens,
(b4) using the transformer module for generating correctional text for corresponding triplets based upon the training text tokens conditioned by the set of training pose tokens, and
(b5) using a loss to maximize for corresponding triplets a probability of generating a ground-truth token given previous tokens.

19. The computer-implemented method as claimed in claim 18, wherein the loss is a cross-entropy loss, the transformer module is an auto-regressive transformer module, and the set of training pose tokens prompt the auto-regressive transformer module.

20. The computer-implemented method as claimed in claim 18, wherein the loss is a cross-entropy loss, the transformer module is an auto-regressive transformer module, and the set of training pose tokens are used in cross-attention mechanisms in the auto-regressive transformer.

21. A computer-implemented method for using a pose generation model for text-based pose editing to generate a new pose from an initial pose and user-generated text, comprising:
(a) electronically accessing from memory using one or more processors: (i) a pose encoder adapted to generate a pose from the user-generated text, (ii) a text conditioning pipeline, (iii) a fusing module, and (iv) a pose decoder; and
(b) electronically generating the new pose from the initial pose and the user-generated text with the pose generation model using one or more processors by
(b1) using the pose encoder for encoding the initial pose into features a,
(b2) using the text conditioning pipeline for tokenizing the user-generated text to create text tokens,
(b3) using the text conditioning pipeline for extracting word encodings from the text tokens and converting the extracted word encoding to a global text representation m,
(b4) using the fusing module for fusing the global text representation m and the features a to output a vector p,
(b5) producing parameters for a distribution N, conditioned on the vector p from fusion of the features a and the global text representation m, and
(b6) using the pose decoder to generate the new pose by sampling a latent variable z_{b} from the distribution N.

22. A computer-implemented method for using a pose generation model for generating correctional pose text to communicate to a user how the user should modify a current pose to obtain a desired pose, comprising:
(a) electronically accessing from memory using one or more processors: (i) a pose encoder, (ii) a transformer module including a transformer adapted to generate the correctional pose text, and (iii) a fusing module; and
(b) electronically generating the correctional pose text with the pose generation model using one or more processors by
(b1) using the pose encoder for encoding the current pose and the desired pose into features a and features b, respectively,
(b2) using the fusing module for fusing the features a and the features b to output a set of pose tokens, and
(b3) using the for generating the correctional pose text based upon the set of pose tokens.
